(19) United States
(12) Patent Application Publication
(10) Pub. No.: US 2004/0126619 A1
(43) Pub. Date: Jul. 1, 2004

(54) Organic electroluminescent element

(76) Inventor: Nobuhiro Nishita, Minami-Ashigara-shi (JP)

Correspondence Address: BIRCH STEWART KOLASCH & BIRCH, PO BOX 747, FALLS CHURCH, VA, 22040-0747, US

(21) Appl. No.: 10/732,451

(22) Filed: Dec. 11, 2003

(30) Foreign Application Priority Data
Dec. 12, 2002 (JP) 2002-361110

(51) Int. Cl. H05B 33/12

(52) U.S. Cl. 428/690; 428/917; 313/504; 313/506

(57) ABSTRACT

An organic electroluminescent element comprising: a substrate; a cathode; at least one organic layer, at least one of the at least one organic layer being a light-emitting layer; and an anode, wherein the element further comprises a mixture layer containing an inorganic metal salt and an electron transporting organic material so that the cathode, the mixture layer and the organic layer are in this order, and the electron transporting organic material is at least one of compounds represented by the formula (A-I) and the formula (B-I) as defined herein.

### FIELD OF THE INVENTION

The present invention relates to an organic electroluminescent element, so-called organic EL device, which can be utilized as back light for full-color display, a flat light source such as a light source for illumination, or as light source arrays in a printer.

### BACKGROUND OF THE INVENTION

In general, the organic electroluminescent (EL) element is constituted by a light-emitting layer and a pair of opposed electrodes (a backside electrode and a transparent electrode) sandwiching the light-emitting layer. When an electric field is applied across a pair of the opposed electrodes, electrons are usually injected from the backside into the light-emitting layer and, at the same time, holes are injected thereinto from the transparent electrode. The electrons and the holes are recombined in the light-emitting layer and, when their energy level returns from conduction band to valence band, the energy is released as light, thus the element emitting light.

The structure of an organic EL element has conventionally been investigated from various aspects, and there has been proposed an organic electroluminescent element having an organic compound layer doped with a metal functioning as a donor dopant provided between the backside electrode of cathode and an organic light-emitting layer in order to reduce the energy barrier which causes trouble upon injection of electrons from the backside electrode into the light-emitting layer and to obtain a high luminance and a high light-emitting efficiency at a low driving voltage (see, for example, JP-A-10-270171).

On the other hand, the organic EL element usually has a laminate structure wherein a transparent electrode (anode)/an organic layer/a backside electrode (cathode) are stacked in this order on a substrate, with light being emitted from the substrate side of the element. Thus, the substrate is required to be transparent, and materials to be used for the substrate are inevitably limited. Also, in the case of using the organic EL element as an actual light source for, for example, a color display, TFT (thin film transistor) elements and wiring are provided on the substrate for forming pixels, and they block off light on the substrate, thus opening ratio (ratio of the actually light-emitting portion to pixel) being decreased.

### SUMMARY OF THE INVENTION

Therefore, an object of the invention is to provide an organic electroluminescent element which emits light with a high luminance and a high efficiency at a low driving voltage, and which is advantageous in view of choice of materials and application to a light source.

The above-described problems can be solved by the following organic electroluminescent element:

(1) An organic electroluminescent element having a cathode, at least one organic layer including a light-emitting layer and an anode in this order on a substrate, which has a mixture layer containing an inorganic metal salt and an electron transporting organic material between the cathode and the organic layer, with the electron transporting organic material being at least one of the compounds represented by the formula (A-I) and the formula (B-I):

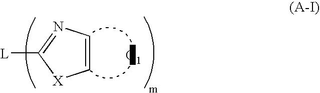

wherein X represents O, S, Se, Te or N—R, R represents a hydrogen atom, an aliphatic hydrocarbyl group, an aryl group or a heterocyclic group, Q₁ represents atoms necessary for forming an aromatic heterocyclic ring (aromatic hetero ring), m represents an integer of 2 or more, and L represents a linking group;

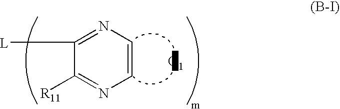

wherein R₁₁ represents a hydrogen atom or a substituent, Q1 represents atoms necessary for forming an aromatic heterocyclic ring, m represents an integer of 2 or more, and L represents a linking group;

(2) The organic electroluminescent element as described in the above (1), wherein the inorganic metal salt is at least one of an alkali metal salt and an alkaline earth metal salt; and

(3) The organic electroluminescent element as described in the above (1) or (2), wherein the concentration of the inorganic metal salt in the mixture layer is 0.1 to 99.0% by weight.

The organic electroluminescent element of the invention is an organic electroluminescent element comprising a substrate having provided thereon a cathode, an organic layer and an anode in this order, which is characterized in that a mixture layer containing an inorganic metal salt and an electron transporting organic material is provided between the cathode and the organic layer.

In the invention, the lowest unoccupied molecular orbital (LUMO) of the organic compound in the organic layer is lowered by providing the mixture layer containing the inorganic metal salt and the electron transporting organic material adjacent to the cathode, which serves to lower the energy barrier upon injection of electron from the cathode. The organic electroluminescent element of the invention permits to lower its driving voltage in comparison with conventional elements.

The element of the invention has the structure wherein a cathode/an organic layer/an anode are provided in this order on a substrate (hereinafter also referred to as “reverse structure”), and hence it is not necessary to take out light from the substrate side, thus a substrate which does not transmit light being usable. This serves to increase choices of the material for substrate. For example, a freely bendable flexible substrate using a polyimide film may be employed. Also, a high opening ratio can be realized when applied to a display. Further, since the cathode is formed as a film prior to the organic layer, it can be avoided to damage the organic layer upon forming the cathode film.

### DETAILED DESCRIPTION OF THE INVENTION

The invention is described in more detail below.

The organic electroluminescent element of the invention is an element having a reverse structure wherein a cathode/an organic layer/an anode are provided in this order on a substrate, with a mixture layer containing an inorganic material and an electron transporting organic material being provided between the cathode and the organic layer.

As a specific stratum structure, there are illustrated a cathode/a light-emitting layer/an anode, a cathode/an electron transporting organic layer/a light-emitting layer/an anode, a cathode/an electron transporting organic layer/a light-emitting layer/a hole transporting organic layer/an anode, a cathode/an electron injecting organic layer/an electron transporting layer/a light-emitting layer/an anode, and a cathode/an electron injecting organic layer/an electron transporting organic layer/a light-emitting layer/a hole transporting organic layer/a hole injecting organic layer/an anode. Here, the mixture layer is provided between the cathode and the organic layer, and the mixture layer may also function as the electron transporting organic layer or the electron injecting organic layer or, alternatively, these layers may separately be provided in addition to the mixture layer.

The light-emitting layer contains a fluorescent light-emitting compound and/or a phosphorescent light-emitting compound, and an emitted light is taken out from the cathode layer side or the anode layer side. Specific examples of the compounds to be used in each of the layers are described in, for example, “Yuki EL Display”, a separate volume of the October Number of “Gekkan Display” (published by Techno-Times Co.).

The substrate and each of the layers are described in detail below.

[1] Mixture Layer

As an inorganic metal salt to be contained in the mixture layer, salts of alkali metals such as Li or alkaline earth metals such as Mg are preferred, and LiF, NaF, KF, RbF, CsF, MgF₂, CaF₂, SrF₂, BaF₂, LiCl, NaCl, KCl, RbCl, CsCl, MgCl₂, CaCl₂, SrCl₂ and BaCl₂ may preferably be used.

In the invention, in view of lowering the energy barrier upon injection of electron and, at the same time, maintaining the concentration of the organic material functioning to transfer electrons in the vicinity of the cathode, the concentration of the inorganic metal salt in the mixture layer is preferably 0.1% by weight to 99.0% by weight, more preferably 1.0 to 80.0% by weight.

The weight ratio of the inorganic metal salt to the electron transporting organic material is preferably 0.1:99.9 to 99:1, more preferably 1:99 to 80:20.

The thickness of the mixture layer is not particularly limited but, in view of forming a uniform film and reducing the driving voltage, it is preferably 1 nm to 200 nm, particularly preferably 20 nm to 80 nm.

The electron transporting organic material to be contained in the mixture layer may be any of those which receive an electron injected from the cathode and transport it. An electron transporting layer or an electron injecting layer may separately be provided in addition to the mixture layer.

As the electron transporting organic material, there may also be used, for example, triazole derivatives, oxazole derivatives, oxadiazole derivatives, fluorenone derivatives, anthraquinodimethane derivatives, anthrone derivatives, diphenylquinone derivatives, thiopyran dioxide derivatives, carbodiimide derivatives, fluorenylidenemethane derivatives, distyrylpyrazine derivatives, aromatic tetracarboxylic acid anhydrides of naphthalene or perylene, phthalocyanine derivatives, metal complexes of, for example, 8-quinolinol derivatives, metallophthalocyanines, metal complexes containing benzoxazole or benzothiazole as a ligand, conductive high polymers such as aniline copolymers, thiopehen oligomers and polythiophene, polythiophene derivatives, polyphenylene derivatives, polyphenylenevinylene derivatives, and polyfluorene derivatives.

In the invention, at least one of the compounds represented by the foregoing formulae (A-I) and (B-I) is used as the electron transporting organic material to be incorporated in the mixture layer. The compounds serve to provide an element having good light-emitting characteristics and a high stability.

First, the compounds represented by the formula (A-I) are described below.

In the formula (A-I), m represents an integer of 2 or more, preferably 2 to 8, more preferably 2 to 6, still more preferably 2 to 4, particularly preferably 2 or 3, most preferably 3.

In the formula (A-I), L represents a linking group. Preferred examples of the linking group represented by L include a single bond and those linking groups formed by C, N, O, S, Si, Ge, etc., more preferred examples include a single bond, an alkylene group, an alkenylene group, an alkynylene group, an arylene group, a divalent heterocyclic group (heterocyclic ring group)(preferably an aromatic heterocyclic ring, more preferably an aromatic heterocyclic ring formed by an azole ring, a thiophene ring or a furan ring), and a group composed of a combination of N and these groups, and still more preferred examples include an arylene group, a divalent aromatic heterocyclic group, and a combination of N and these.

Specific examples of the linking group represented by L include the following ones in addition to a single bond.

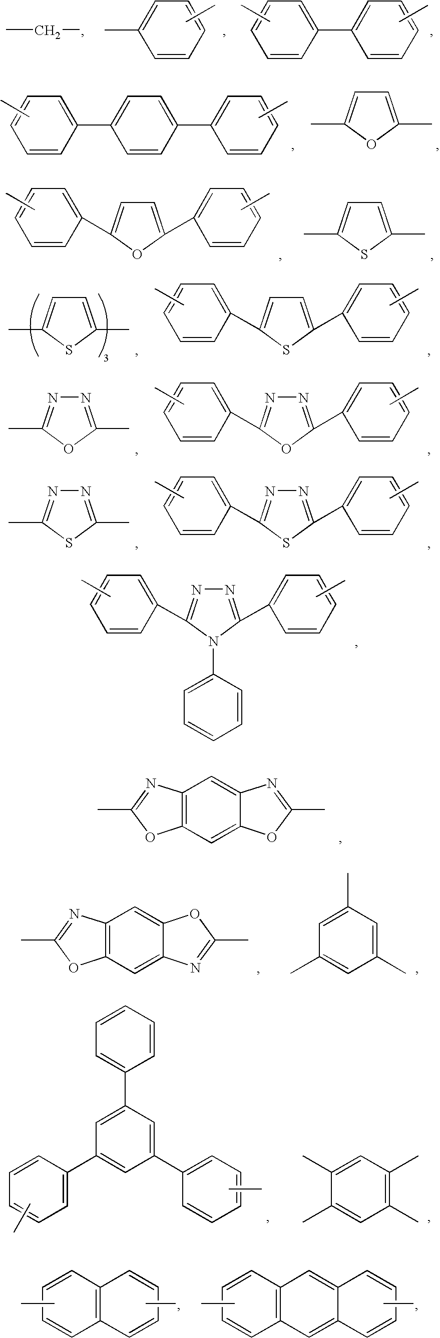

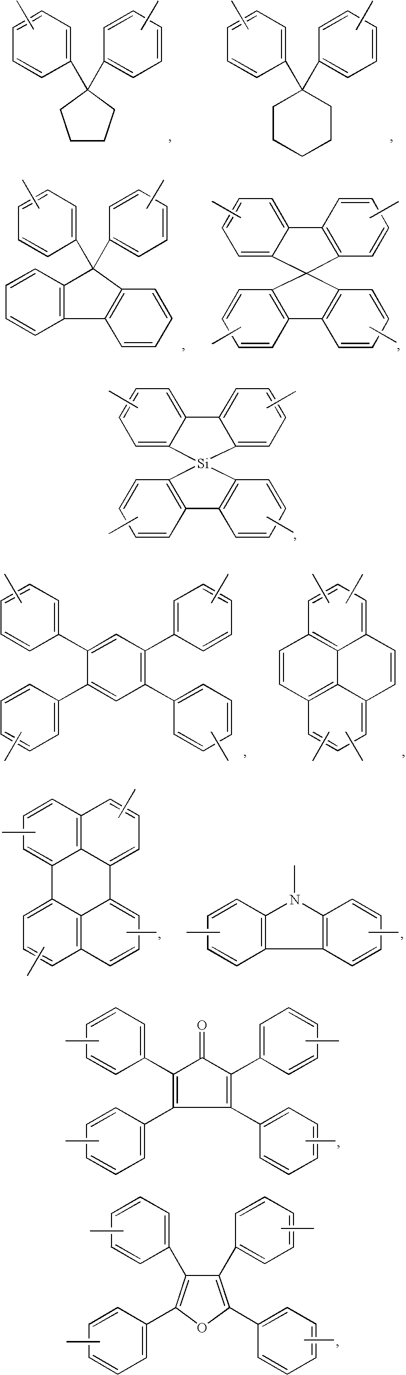

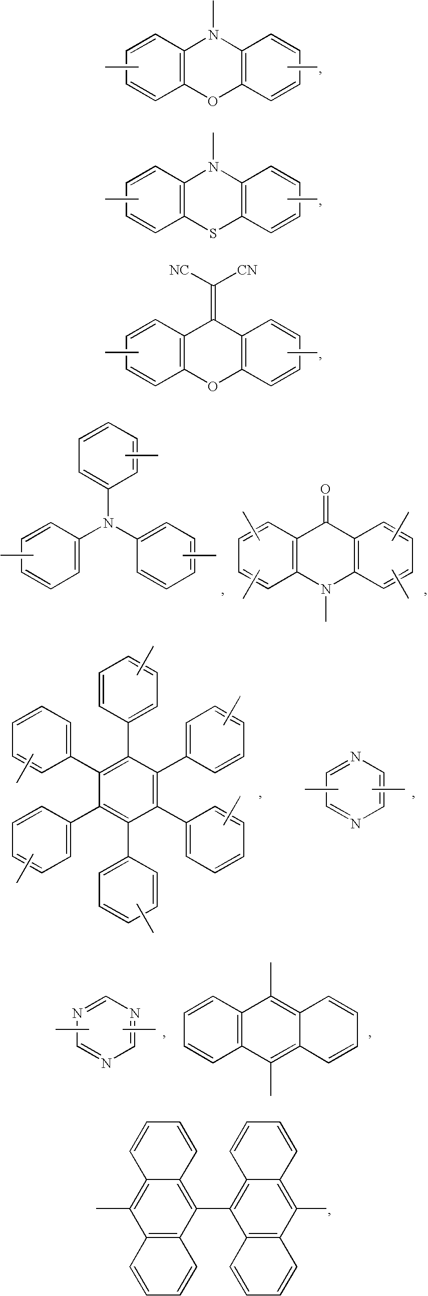

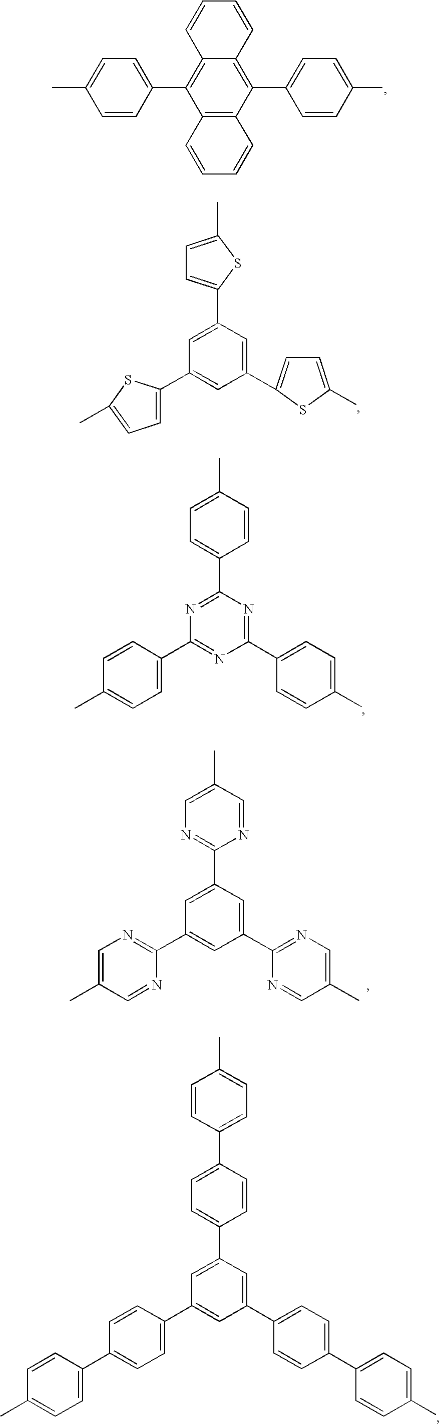

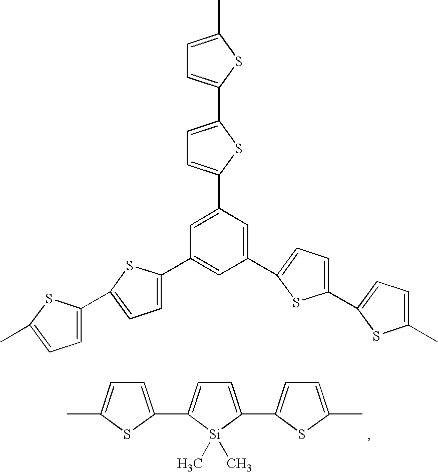

The linking group represented by L may have a substituent. Preferred examples of the substituent for L include an alkyl group, an alkenyl group, an alkynyl group, an aryl group, an alkoxy group, an aryloxy group, an acyl group, a halogen atom, a cyano group, a heterocyclic group and a silyl group, more preferred examples thereof include an alkyl group, an alkenyl group, an alkynyl group, an aryl group, an alkoxy group, an aryloxy group, a halogen atom, a cyano group and an aromatic heterocyclic group, and still more preferred examples thereof include an alkyl group, an aryl group and an aromatic heterocyclic group.

In the formula (A-I), X represents O, S, Se, Te or N—R. R represents a hydrogen atom, an aliphatic hydrocarbyl group, an aryl group or a heterocyclic group.

Preferred examples of the aliphatic hydrocarbyl group represented by R include an alkyl group (containing preferably 1 to 20 carbon atoms, more preferably 1 to 12 carbon atoms, particularly preferably 1 to 8 carbon atoms; e.g., methyl, ethyl, iso-propyl, tert-butyl, n-octyl, n-decyl, n-hexadecyl, cyclopropyl, cyclopentyl and cyclohexyl), an alkenyl group (containing preferably 2 to 20 carbon atoms, more preferably 2 to 12 carbon atoms, particularly preferably 2 to 8 carbon atoms; e.g., vinyl, allyl, 2-butenyl and 3-pentenyl), analkynyl group (containing preferably 2 to 20 carbon atoms, more preferably 2 to 12 carbon atoms, particularly preferably 2 to 8 carbon atoms; e.g., propargyl and 3-pentynyl), with an alkyl group and an alkenyl group being more preferred.

Preferred examples of the aryl group represented by R are those which contain preferably 6 to 30 carbon atoms, more preferably 6 to 20 carbon atoms, particularly preferably 6 to 12 carbon atoms, and include phenyl, 2-methylphenyl, 3-methylphenyl, 4-methylphenyl, 4-methoxyphenyl, 3-trifluoromethylphenyl, pentafluorophenyl, 2-biphenylyl, 3-biphenylyl, 4-biphenylyl, 1-naphthyl, 2-naphthyl and 1-pyrenyl.

The heterocyclic group represented by R is a heterocyclic group containing a single ring or a condensed ring (a heterocyclic group containing preferably 1 to 20 carbon atoms, preferably 1 to 12 carbon atoms, still more preferably 2 to 10 carbon atoms) and is preferably an aromatic heterocyclic group containing at least one of a nitrogen atom, an oxygen atom and a selenium atom. Specific examples of the heterocyclic group represented by R include pyrrolidine, piperidine, pyrrole, furan, thiophene, imidazoline, imidazole, benzimidazole, naphthimidazole, thiazolidine, thiazole, benzothiazole, naphthothiazole, isothiazole, oxazoline, oxazole, benzoxazole, naphthoxazole, isoxazole, selenazole, benzoselenazole, naphthoselenazole, pyridine, quinoline, isoquinoline, indole, indolenine, pyrazole, pyrazine, pyrimidine, pyridazine, triazine, indazole, purine, phthalazine, naphthyridine, quinoxaline, quinazoline, cinnoline, pteridine, phenanthridine, phenanthroline and tetrazaindene. Preferred examples thereof include furan, thiophene, pyridine, quinoline, pyrazine, pyrimidine, pyridazine, triazine, phthalazine, naphthyridine, quinoxaline and quinazoline, more preferred examples include furan, thiophene, pyridine and quinoline, and particularly preferred is quinoline.

The aliphatic hydrocarbyl group, the aryl group and the heterocyclic group represented by R may have a substituent or substituents. As such substituents, there are illustrated, for example, an alkyl group (containing preferably 1 to 30 carbon atoms, more preferably 1 to 20 carbon atoms, particularly preferably 1 to 10 carbon atoms; e.g., methyl, ethyl, iso-propyl, tert-butyl, n-octyl, n-decyl, n-hexadecyl, cyclopropyl, cyclopentyl or cyclohexyl), an alkenyl group (containing preferably 2 to 30 carbon atoms, more preferably 2 to 20 carbon atoms, particularly preferably 2 to 10 carbon atoms; e.g., vinyl, allyl, 2-butenyl or 3-pentenyl), an alkynyl group (containing preferably 2 to 30 carbon atoms, more preferably 2 to 20 carbon atoms, particularly preferably 2 to 10 carbon atoms; e.g., propargyl or 3-pentynyl), an aryl group (containing preferably 6 to 30 carbon atoms, more preferably 6 to 20 carbon atoms, particularly preferably 6 to 12 carbon atoms; e.g., phenyl, p-methylphenyl or naphthyl), an amino group (containing preferably 0 to 30 carbon atoms, more preferably 0 to 20 carbon atoms, particularly preferably 0 to 10 carbon atoms; e.g., amino, methylamino, dimethylamino, diethylamino, dibenzylamino, diphenylamino or ditolylamino),

an alkoxy group (containing preferably 1 to 30 carbon atoms, more preferably 1 to 20 carbon atoms, particularly preferably 1 to 10 carbon atoms; e.g., methoxy, ethoxy, butoxy or 2-ethylhexyloxy), an aryloxy group (containing preferably 6 to 30 carbon atoms, more preferably 6 to 20 carbon atoms, particularly preferably 6 to 12 carbon atoms; e.g., phenyloxy, 1-naphthyloxy or 2-napthyloxy), an acyl group (containing preferably 1 to 30 carbon atoms, more preferably 1 to 20 carbon atoms, particularly preferably 2 to 12 carbon atoms; e.g., acetyl, benzoyl, formyl or pivaloyl), an alkoxycarbonyl group (containing preferably 2 to 30 carbon atoms, more preferably 2 to 20 carbon atoms, particularly preferably 2 to 12 carbon atoms; e.g., methoxycarbonyl or ethoxycarbonyl), an aryloxycarbonyl group (containing preferably 7 to 30 carbon atoms, more preferably 7 to 20 carbon atoms, particularly preferably 7 to 12 carbon atoms; e.g., phenyloxycarbonyl), an acyloxy group (containing preferably 2 to 30 carbon atoms, more preferably 2 to 20 carbon atoms, particularly preferably 2 to 10 carbon atoms; e.g., acetoxy or benzoyloxy),

an acylamino group (containing preferably 2 to 30 carbon atoms, more preferably 2 to 20 carbon atoms, particularly preferably 2 to 10 carbon atoms; e.g., acetylamino or benzoylamino), an alkoxycarbonylamino group (containing preferably 2 to 30 carbon atoms, more preferably 2 to 20 carbon atoms, particularly preferably 2 to 12 carbon atoms; e.g., methoxycarbonylamino), an aryloxycarbonylamino group (containing preferably 7 to 30 carbon atoms, more preferably 7 to 20 carbon atoms, particularly preferably 7 to 12 carbon atoms; e.g., phenyloxycarbonylamino) a sulfonylamino group (containing preferably 1 to 30 carbon atoms, more preferably 1 to 20 carbon atoms, particularly preferably 1 to 12 carbon atoms; e.g., methanesulfonylamino or benzenesulfonylamino),

a sulfamoyl group (containing preferably 0 to 30 carbon atoms, more preferably 0 to 20 carbon atoms, particularly preferably 0 to 12 carbon atoms; e.g., sulfamoyl, methylsulfamoyl, dimethylsulfamoyl or phenylsulfamoyl), a carbamoyl group (containing preferably 1 to 30 carbon atoms, more preferably 1 to 20 carbon atoms, particularly preferably 1 to 12 carbon atoms; e.g., carbamoyl, methylcarbamoyl, diethylcarbamoyl or phenylcarbamoyl), an alkylthio group (containing preferably 1 to 30 carbon atoms, more preferably 1 to 20 carbon atoms, particularly preferably 1 to 12 carbon atoms; e.g., methylthio or ethylthio), an arylthio group (containing preferably 6 to 30 carbon atoms, more preferably 6 to 20 carbon atoms, particularly preferably 6 to 12 carbon atoms; e.g., phenylthio), a sulfonyl group (containing preferably 1 to 30 carbon atoms, more preferably 1 to 20 carbon atoms, particularly preferably 1 to 12 carbon atoms; e.g., mesyl or tosyl), a sulfinyl group (containing preferably 1 to 30 carbon atoms, more preferably 1 to 20 carbon atoms, particularly preferably 1 to 12 carbon atoms; e.g., methanesulfinyl or benzenesulfinyl), a ureido group (containing preferably 1 to 30 carbon atoms, more preferably 1 to 20 carbon atoms, particularly preferably 1 to 12 carbon atoms; e.g., ureido, methylureido or phenylureido), a phosphoric acid amido group (containing preferably 1 to 30 carbon atoms, more preferably 1 to 20 carbon atoms, particularly preferably 1 to 12 carbon atoms; e.g., diethylphosphoric acid amido or phenylphosphoric acid amido),

a hydroxyl group, a mercapto group, a halogen atom (e.g., a fluorine atom, a chlorine atom, a bromine atom or an iodine atom), a cyano group, a sulfo group, a carboxyl group, a nitro group, a hydroxamic acid group, a sulfino group, a hydrazino group, an imino group, a heterocyclic group (containing preferably 1 to 30 carbon atoms, more preferably 1 to 12 carbon atoms and containing, for example, a nitrogen atom, an oxygen atom or a sulfur atom as a hetero atom; specific examples thereof being imidazolyl, pyridyl, quinolyl, furyl, thienyl, piperidyl, morpholino, benzoxazolyl, benzimidazolyl, benzothiazolyl, carbazolyl and azepinyl), and a silyl group (containing preferably 3 to 40 carbon atoms, more preferably 3 to 30 carbon atoms, particularly preferably 3 to 24 carbon atoms; e.g., trimethylsilyl or triphenylsilyl).

These substituents may further be substituted. Also, in the case where two or more substituents exist, they may be the same or different from each other and, if possible, they may be connected to each other to form a ring.

Where R represents a heterocyclic ring, preferred examples of the substituent include an alkyl group, an alkenyl group, an alkynyl group, an aryl group, an amino group, an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a sulfonyl group, a halogen atom, a cyano group and a heterocyclic group, more preferred examples thereof include an alkyl group, an alkenyl group, an aryl group, an alkoxy group, an aryloxy group, a halogen atom, a cyano group and a heterocyclic group, still more preferred examples thereof include an alkyl group, an aryl group, an alkoxy group, an aryloxy group and an aromaticf heterocyclic group, and particularly preferred examples thereof include an alkyl group, an aryl group, an alkoxy group and an aromatic heterocyclic group.

X is preferably O, S or N—R, more preferably O or N—R, still more preferably N—R, particularly preferably N-Ar (Ar being an aryl group or an aromatic azole group, more preferably an aryl group containing 6 to 30 carbon atoms or an aromatic azole group containing 2 to 30 carbon atoms, still more preferably an aryl group containing 6 to 20 carbon atoms or an aromatic azole group containing 2 to 16 carbon atoms, particularly preferably an aryl group containing 6 to 12 carbon atoms or an aromatic azole group containing 2 to 10 carbon atoms) In the formula (A-I), Q₁ represents atoms necessary for forming an aromatic heterocyclic ring. The aromatic heterocyclic ring formed by Q₁ is preferably a 5- or 6-membered aromatic heterocyclic ring, more preferably a 5- or 6-membered, nitrogen-containing atomatic heterocyclic ring, still more preferably a 6-membered, nitrogen-containing aromatic heterocyclic ring.

Specific examples of the aromatic heterocyclic ring formed by Q₁ include furan, thiophene, pyran, pyrrole, imidazole, pyrazole, pyridine, pyrazine, pyrimidine, pyridazine, thiazole, oxazole, isothiazole, isoxazole, thiadiazole, oxadiazole, triazole, selenazole and tellurazole. Preferred examples thereof include pyridine, pyrazine, pyrimidine and pyridazine. More preferred are pyridine and pyrazine, with pyridine being still more preferred.

The aromatic heterocyclic ring formed by Q₁ may be condensed with other ring to form a condensed ring, or may have a substituent. As the substituent, those which have been illustrated as substituents for the heterocyclic group represented by R in the formula (A-I) may be employed, with preferred substituents being the same as described there.

Of the compounds represented by the formula (A-I), those which are represented by the following formula (A-II) are preferred.

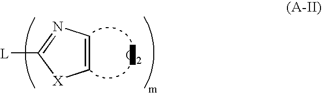

In the formula (A-II), m, L and X are the same as those defined with respect to the formula (A-I), and preferred scopes thereof are also the same. Q₂ represents atoms necessary for forming a nitrogen-containing aromatic heterocyclic ring.

The nitrogen-containing aromatic heterocyclic ring formed by Q₂ is preferably a 5- or 6-membered, nitrogen-containing aromatic heterocyclic ring, more preferably a 6-membered, nitrogen-containing aromatic heterocyclic ring.

Specific examples of the aromatic heterocyclic ring formed by Q₂ include pyrrole, imidazole, pyrazole, pyridine, pyrazine, pyrimidine, pyridazine, thiazole, oxazole, isothiazole, isoxazole, thiadiazole, oxadiazole, triazole, selenazole and tellurazole. Preferred are pyridine, pyrazine, pyrimidine and pyridazine, with pyridine and pyrazine being more preferred, and pyridine being still more preferred.

The aromatic heterocyclic ring formed by Q₂ may be condensed with other ring to form a condensed ring, or may have a substituent. As the substituent, those which have been illustrated as substituents for the heterocyclic group represented by R in the formula (A-I) may be employed, with preferred substituents being the same as described there.

Of the compounds represented by the formula (A-I), those which are represented by the following formula (A-III) are more preferred.

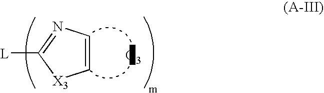

In the formula (A-III), m and L are the same as those defined with respect to the formula (A-I), and preferred scopes thereof are also the same as described there. X₃ represents O, S or N—R. R is the same as that defined with respect to the formula (A-I), and preferred scope thereof is also the same as described there. Q₃ represents atoms necessary for forming a nitrogen-containing aromatic heterocyclic ring.

Specific examples of the aromatic heterocyclic ring formed by Q₃ include pyridine, pyrazine, pyrimidine, pyridazine and triazine. Preferred are pyridine, pyrazine, pyrimidine and pyridazine, with pyridine and pyrazine being more preferred, and pyridine being still more preferred.

The 6-membered aromatic heterocyclic ring formed by Q₃ may be condensed with other ring to form a condensed ring, or may have a substituent. As the substituent, those which have been illustrated as substituents for the heterocyclic group represented by R in the formula (A-I) may be employed, with preferred substituents being the same as described there.

Of the compounds represented by the formula (A-I), those which are represented by the following formula (A-IV) are still more preferred.

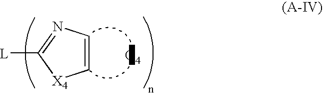

In the formula (A-IV), L is the same as that defined with respect to the formula (A-I), and preferred scope thereof is also the same as described there. X₄ is the same as X₃ in the formula (A-I), and preferred scope thereof is also the same as described there. Q₄ is the same as Q₃ in the formula (A-III), and preferred scope thereof is also the same as described there. n represents an integer of 2 to 8, preferably 2 to 6, more preferably 2 to 4, still more preferably 2 or 3, particularly preferably 3.

Of the compounds represented by the formula (A-I), those which are represented by the following formula (A-IV) are still more preferred.

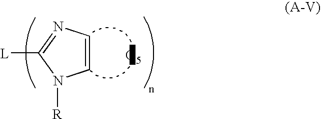

In the formula (A-V), L is the same as that defined with respect to the formula (A-I), and preferred scope thereof is also the same as described there. R is the same as that defined with respect to the formula (A-I), and preferred scope thereof is also the same as described there. Q₅ is the same as Q₃ in the formula (A-III), and preferred scope thereof is also the same as described there. n is the same as that defined with respect to the formula (A-IV), and preferred scope thereof is also the same as described there.

Of the compounds represented by the formula (A-I), those which are represented by the following formula (A-VI) are still more preferred.

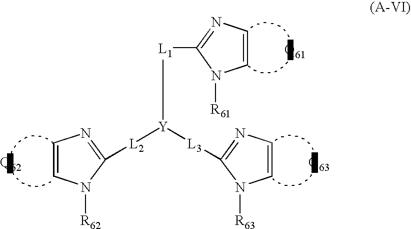

In the formula (A-VI), R₆₁, R₆₂ and R₆₃ are the same as R in the formula (A-I), and preferred scopes thereof are also the same as described there. Q₆₁, Q₆₂ and Q₆₃ are the same as Q₃ in the formula (A-III), and preferred scopes thereof are also the same as described there. L₁, L₂ and L₃ are the same as L in the formula (A-I).

L₁, L₂ and L₃ each preferably represents a single bond, an arylene group, a divalent aromatic heterocyclic group or a linking group comprising a combination thereof, more preferably a single bond, a linking group comprising benzene, naphthalene, anthracene, pyridine, pyrazine, thiophene, furan, oxazole, thiazole, oxadiazole, thiadiazole or triazole, or a combination thereof, still more preferably a single bond or a linking group comprising benzeneorthiophene, or a combination thereof, particularly preferably a single bond or a linking group comprising benzene, or a combination thereof, most preferably a single bond.

L₁, L₂ and L₃ may have a substituent and, as the substituent, those referred to as substituents for the heterocyclic group represented by A in the formula (A-I) may be employed.

Y represents a nitrogen atom or a 1,3,5-benzenetriyl group, and the latter may have a substituent at 2-, 4- or 6-position. Examples of such substituent include an alkyl group, an aryl group and a halogen atom. Y is preferably a nitrogen atom or an unsubstituted 1,3,5-benzenetriyl group, with an unsubstituted 1,3,5-benzenetriyl group being more preferred.

Of the compounds represented by the formula (A-I), compounds represented by the following formula (A-VII) are particularly preferred.

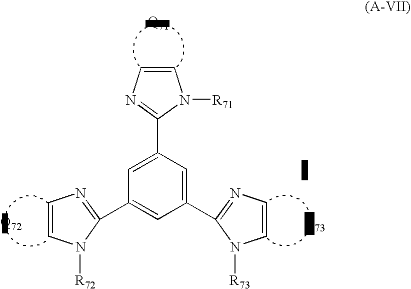

In the formula (A-VII), R₇₁, R₇₂ and R₇₃ are the same as R in the formula (A-I), and preferred scopes thereof are also the same as described there. Q₇₁, Q₇₂ and Q₇₃ are the same as Q₃ in the formula (A-III), and preferred scopes thereof are also the same as described there.

Of the compounds represented by the formula (A-I), compounds represented by the following formula (A-VIII) are most preferred.

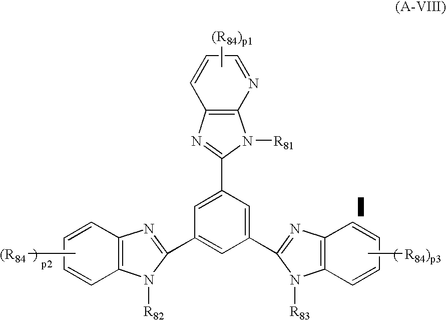

In the formula (A-VIII), R₈₁, R₈₂ and R₈₃ are the same as R in the formula (A-I), and preferred scopes thereof are also the same as described there. R₈₄, R₈₅ and R₈₆ each has a substituent. As the substituent, those referred to as substituents for the heterocyclic group represented by R in the formula (A-I) may be employed, with preferred substituents also being the same as described there. Also, if possible, the substituents may be connected to each other to form a ring. p₁, p₂ and p₃ each represents an integer of 0 to 3, preferably 0 to 2, more preferably 0 or 1, still more preferably 0.

Next, description is given with respect to the formula (B-I).

In the formula (B-I), m and L are the same as those defined with respect to the formula (A-I), and preferred scopes thereof are also the same as that described there. Q₁ is the same as defined with respect to the formula (A-I), and preferred scope is also the same as described there. R₁₁ represents a hydrogen atom or a substituent. As the substituent represented by R₁₁, there may be employed, for example, those which have been referred to as substituents for the heterocyclic group represented by R in the formula (A-I).

The substituent represented by R₁₁ is preferably an aliphatic hydrocarbyl group, an aryl group or an aromatic heterocyclic group, more preferably an alkyl group (containing preferably 1 to 20 carbon atoms, more preferably 1 to 12 carbon atoms, particularly preferably 1 to 8 carbon atoms; e.g., methyl, ethyl, iso-propyl, tert-butyl, n-octyl, n-decyl, n-hexadecyl, cyclopropyl, cyclopentyl or cyclohexyl), an aryl group (containing preferably 6 to 30 carbon atoms, more preferably 6 to 20 carbon atoms, particularly preferably 6 to 12 carbon atoms; e.g., phenyl, 2-methylphenyl, 3-methylphenyl, 4-methylphenyl, 4-methoxyphenyl, 3-trifluoromethylphenyl, pentafluorophenyl, 1-naphthyl or 2-naphthyl), or an aromatic heterocyclic group (an aromatic heterocyclic group containing preferably 1 to 20 carbon atoms, more preferably 1 to 12 carbon atoms, still more preferably 2 to 10 carbon atoms and, more preferably, an aromatic heterocyclic group containing at least one of a nitrogen atom, an oxygen atom, a sulfur atom and a selenium atom; examples of the aromatic heterocyclic ring including pyrrolidine, piperidine, pyrrole, furan, thiophene, imidazoline, imidazole, benzimidazole, naphthimidazole, thiazolidine, thiazolidine, thiazole, benzothiazole, naphthothiazole, isothiazole, oxazoline, oxazole, benzoxazole, naphthoxazole, isoxazole, selenazole, benzoselenazole, naphthoselenazole, pyridine, quinoline, isoquinoline, indole, indolenine, pyrazole, pyrazine, pyrimidine, pyridazine, triazine, indazole, purine, phthalazine, naphthyridine, quinoxaline, quinazoline, cinnoline, pteridine, phenanthridine, phenanthroline, tetrazaindene and carbazole, with preferred examples thereof being furan, thiophene, pyridine, quinoline, pyrazine, pyrimidine, pyridazine, triazine, phthalazine, naphthyridine, quinoxaline and quinazoline, more preferred examples thereof being furan, thiophene, pyridine and quinoline, still more preferred examples thereof are quinoline), with an aryl group and an aromatic heterocyclic group being more preferred. The substituents represented by R₁₁ may further be substituted or, if possible, may be connected to each other to form a ring.

Of the compounds represented by the formula (B-I), compounds represented by the following formula (B-II) are more preferred.

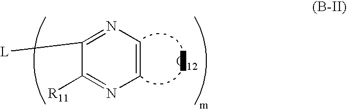

In the formula (B-II), m and L are the same as those defined with respect to the formula (A-I), and preferred scopes thereof are also the same as described there. Q₁₂ is the same as Q₂ in the formula (A-II), and preferred scope is also the same as that described there. R₁₁ is the same as defined with respect to the formula (B-I), and preferred scope thereof is the same as described there.

Of the compounds represented by the formula (B-I), compounds represented by the following formula (B-III) are still more preferred.

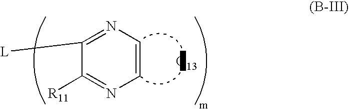

In the formula (B-III), m and L are the same as those defined with respect to the formula (A-I), and preferred scopes thereof are also the same as described there. Q₁₃ is the same as Q₃ in the formula (A-III), and preferred scope is also the same as that described there. R₁₁ is the same as defined with respect to the formula (B-I), and preferred scope thereof is the same as described there.

Of the compounds represented by the formula (B-I), compounds represented by the following formula (B-IV) are particularly preferred.

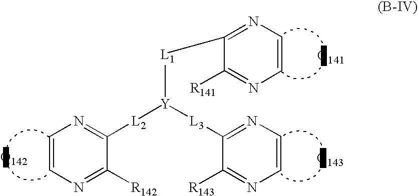

In the formula (B-IV), L₁, L₂, L₃ and Y are the same as those defined with respect to the formula (A-VI), and preferred scopes thereof are also the same as described there. Q₁₄₁, Q₁₄₂ and Q₁₄₃ are the same as Q₃ in the formula (A-III), and preferred scopes are also the same as described there. R₁₄₁, R₁₄₂ and R₁₄₃ are the same as R₁₁ in the formula (B-I), and preferred scope thereof is the same as described there.

Of the compounds represented by the formula (B-I), compounds represented by the following formula (B-V) are most preferred.

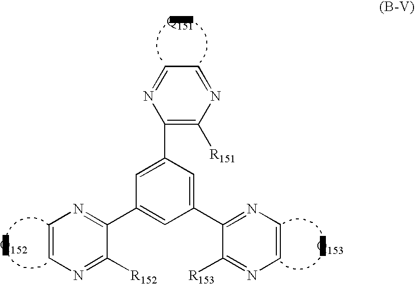

In the formula (B-V), Q₁₅₁, Q₁₅₂ and Q₁₅₃ are the same as Q₃ in the formula (A-III), and preferred scopes are also the same as described there. R₁₅₁, R₁₅₂ and R₁₅₃ are the same as R₁₁ in the formula (B-I), and preferred scope thereof is the same as described there.

Specific examples of the compounds represented by the formula (A-I) or (B-I) are illustrated below which, however, do not limit the invention in any way.

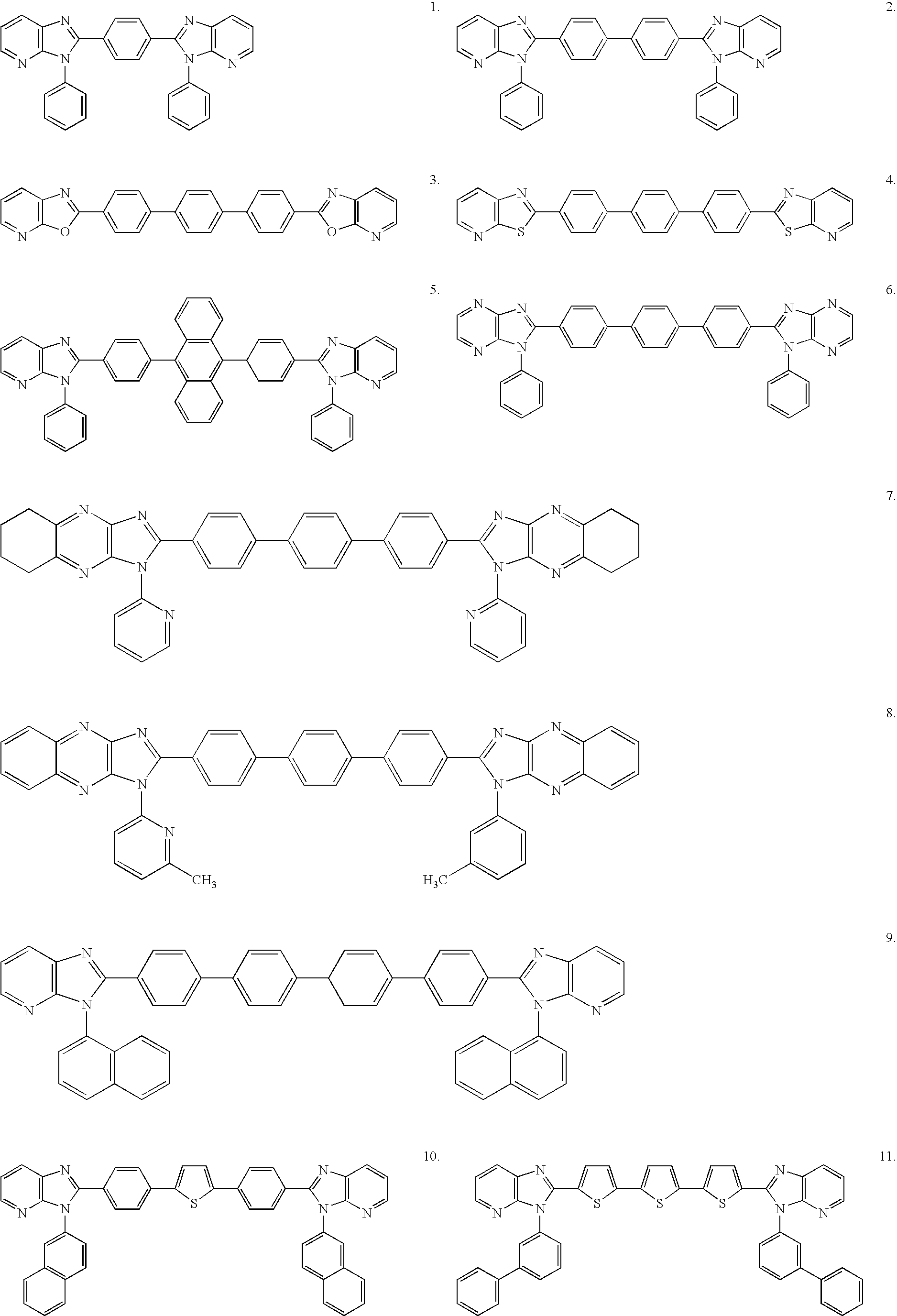

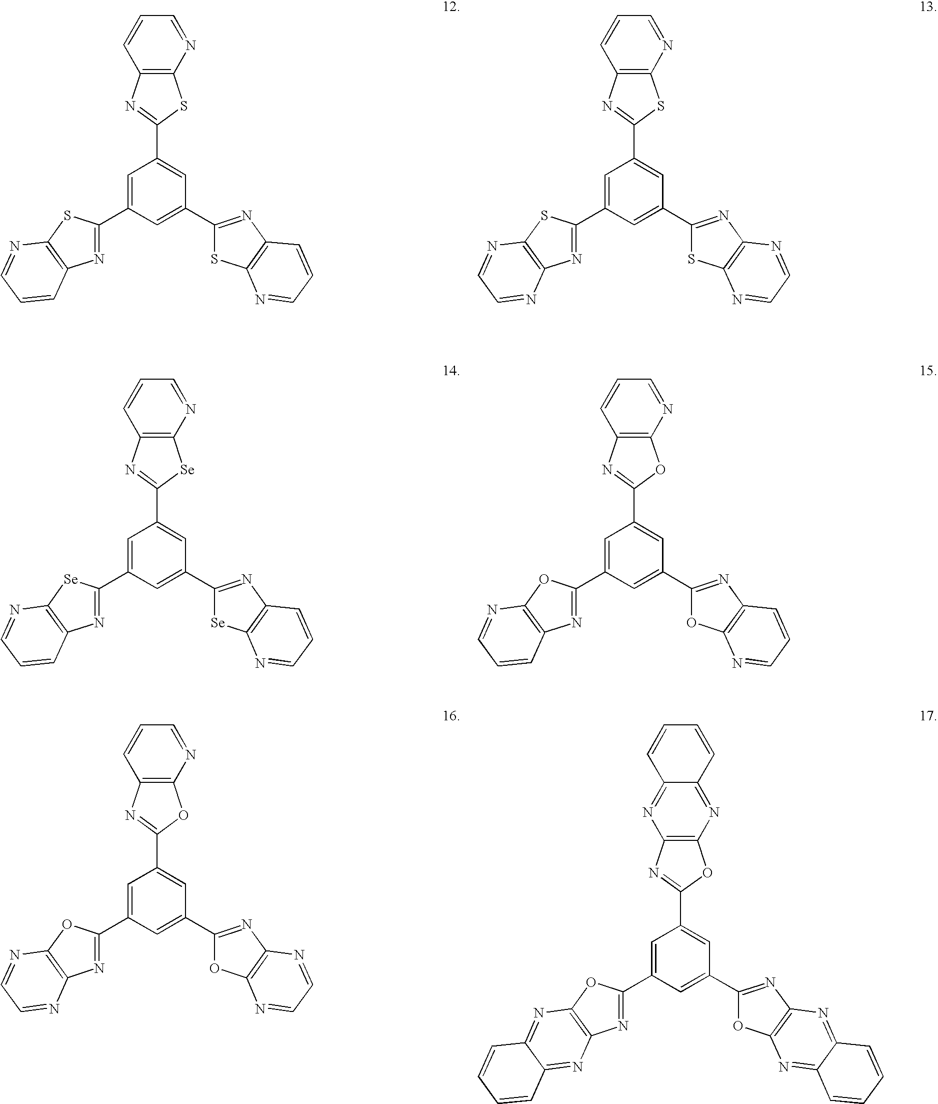

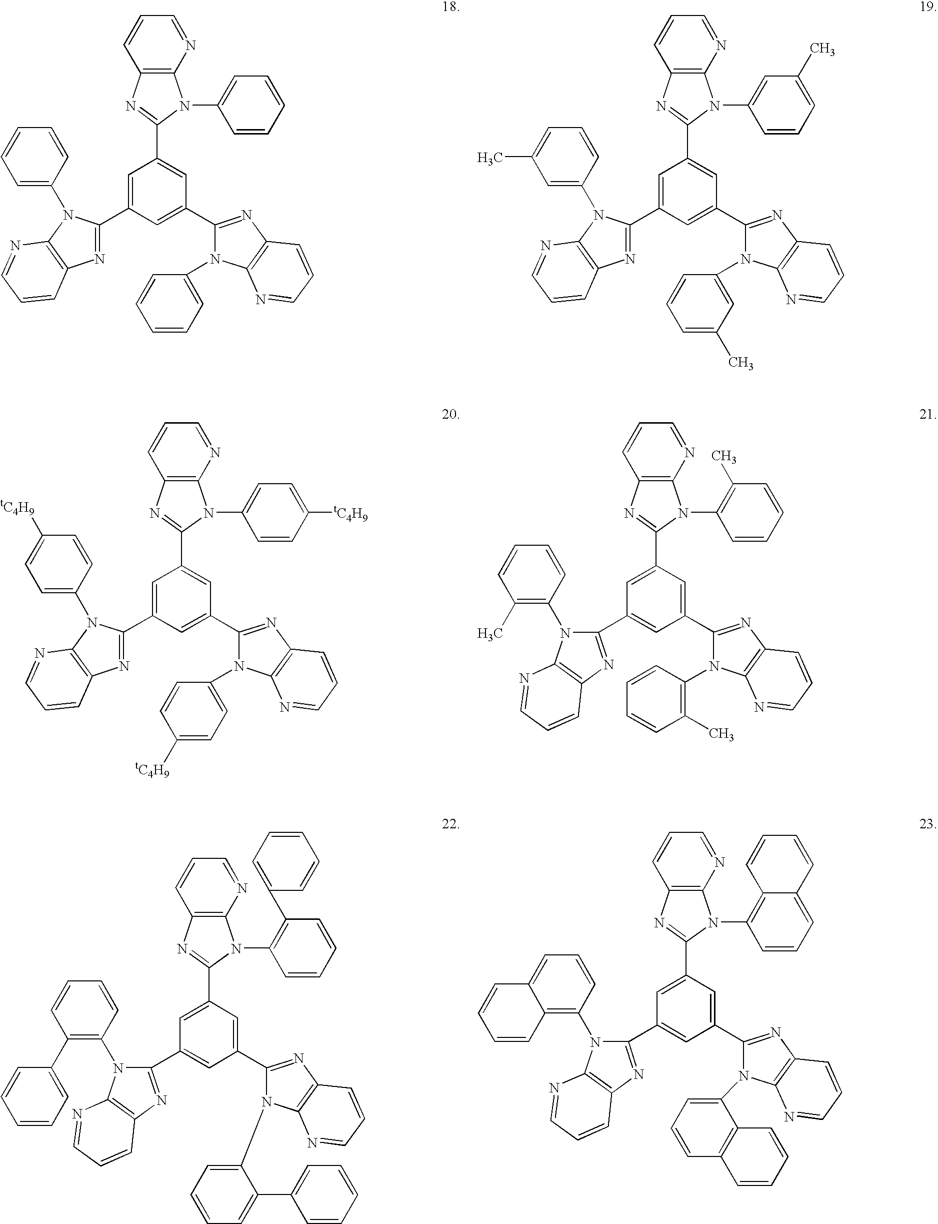

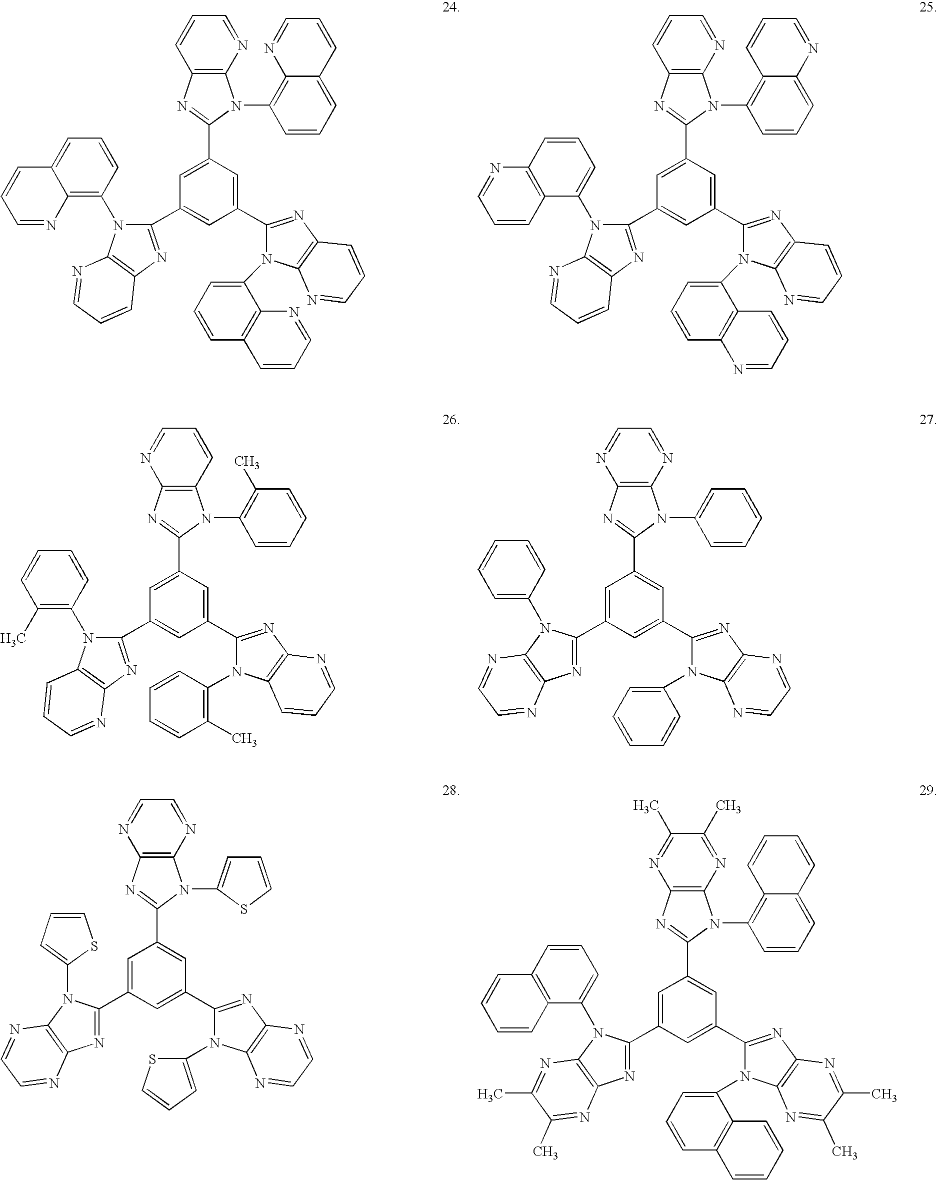

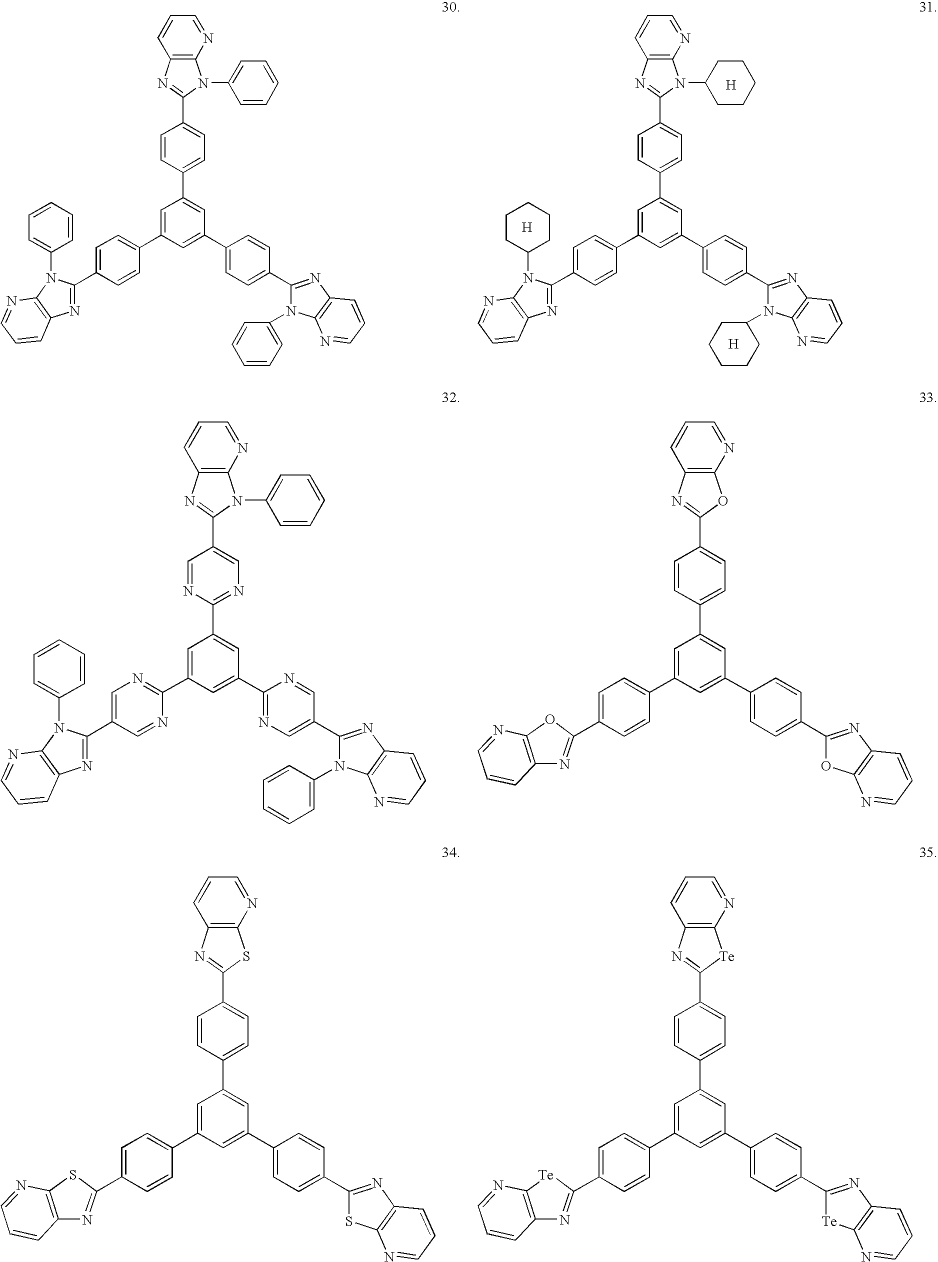

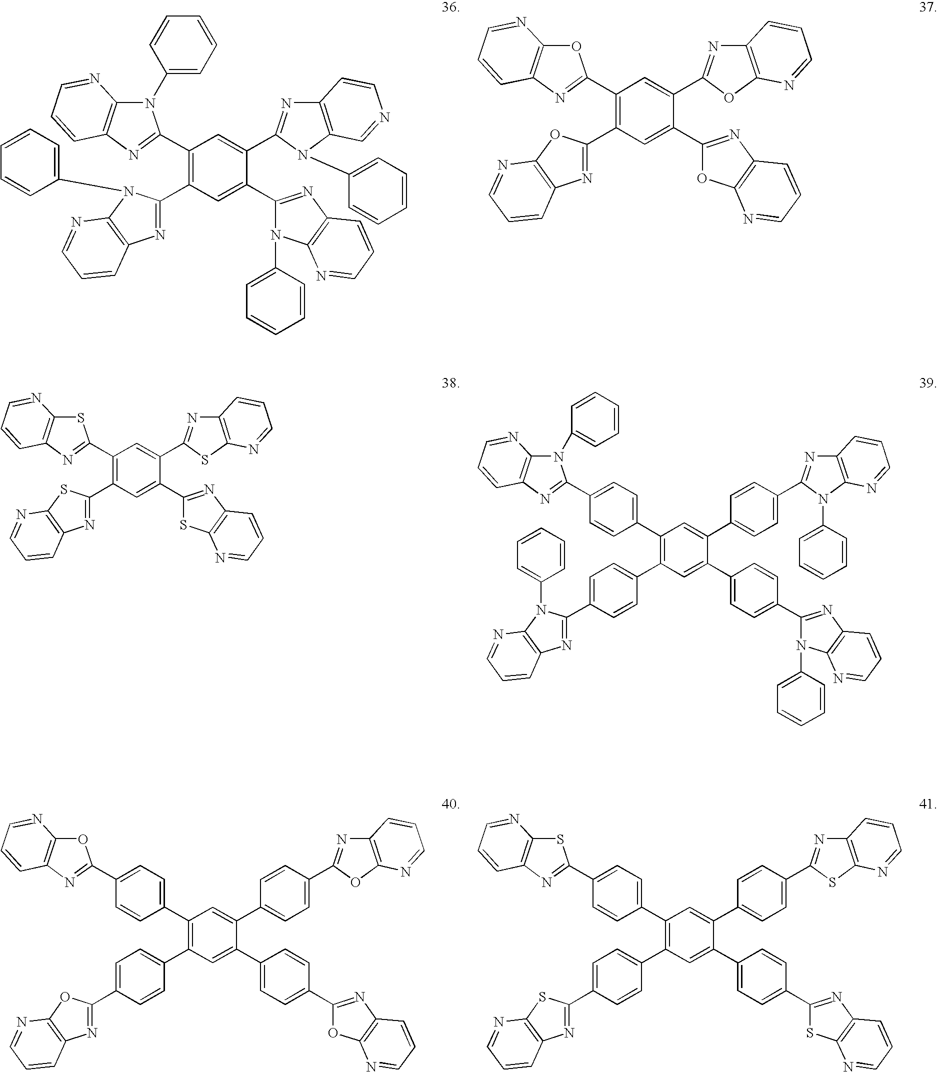

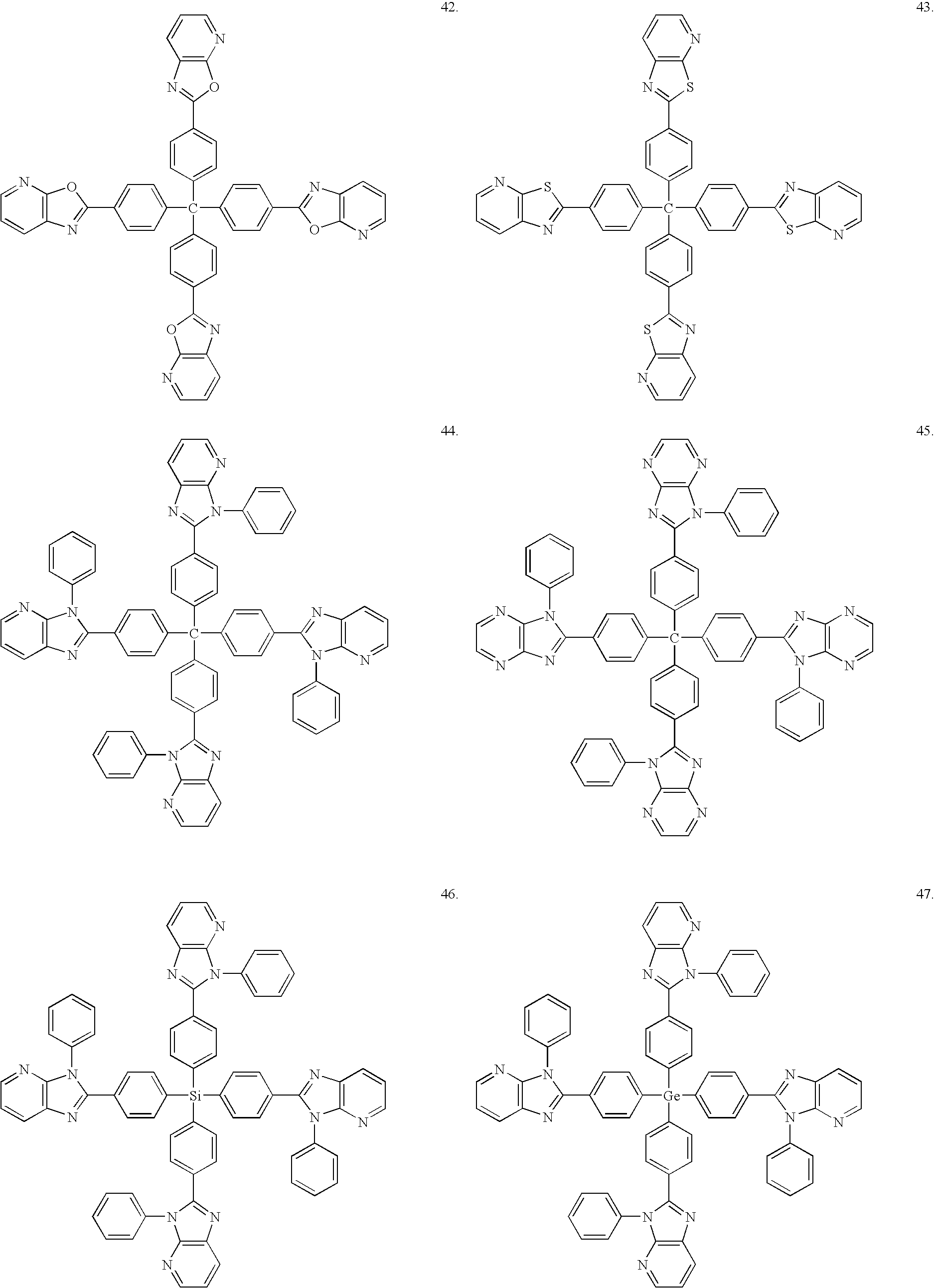

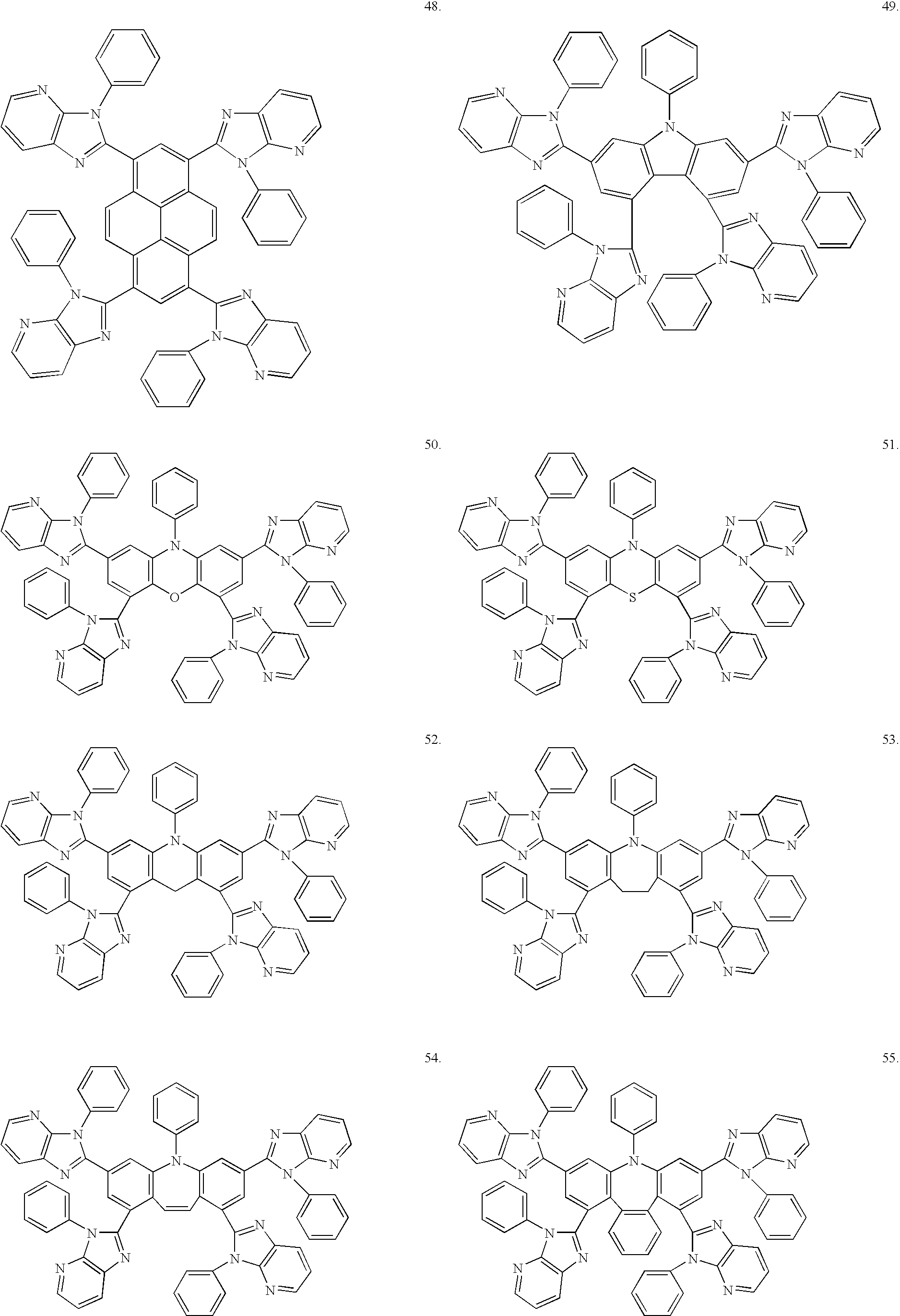

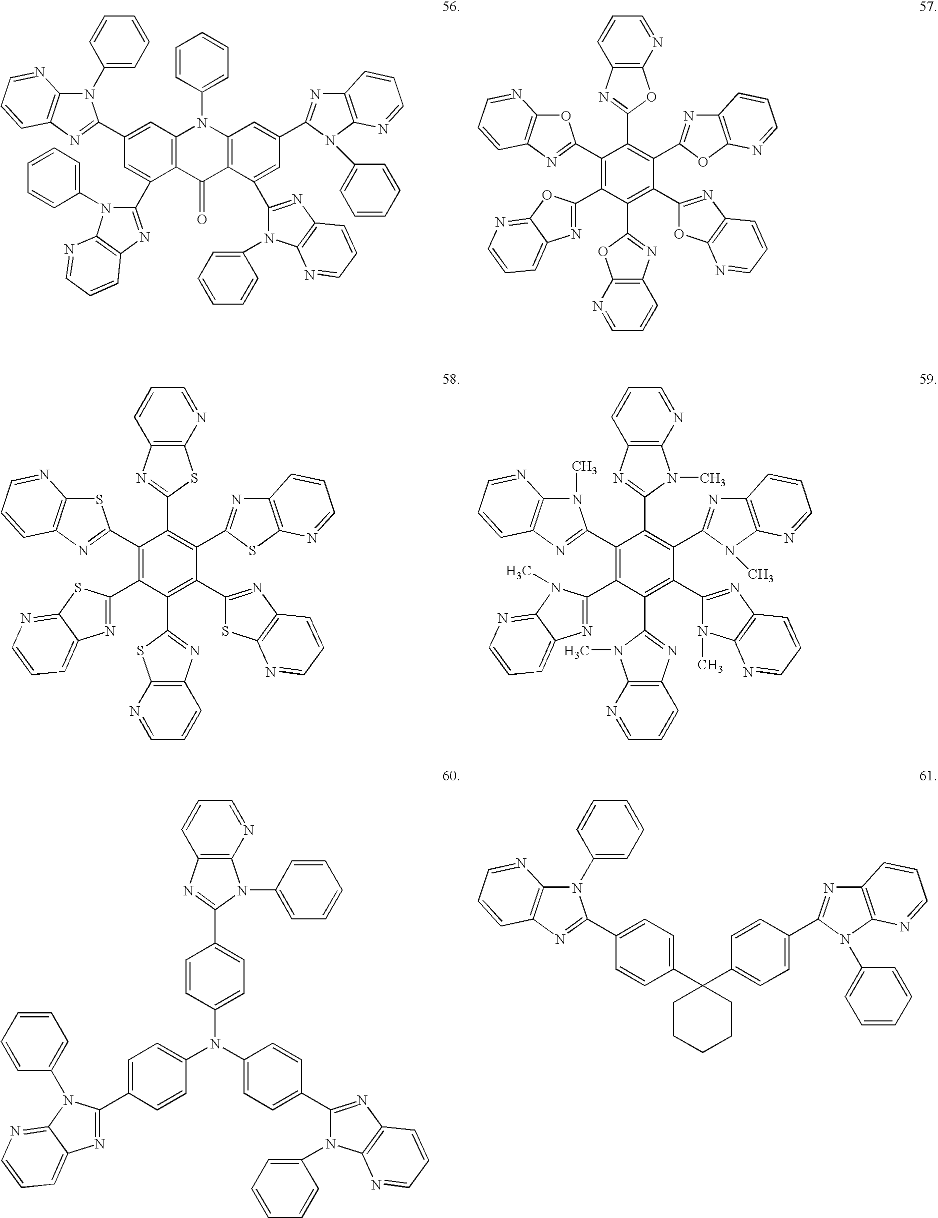

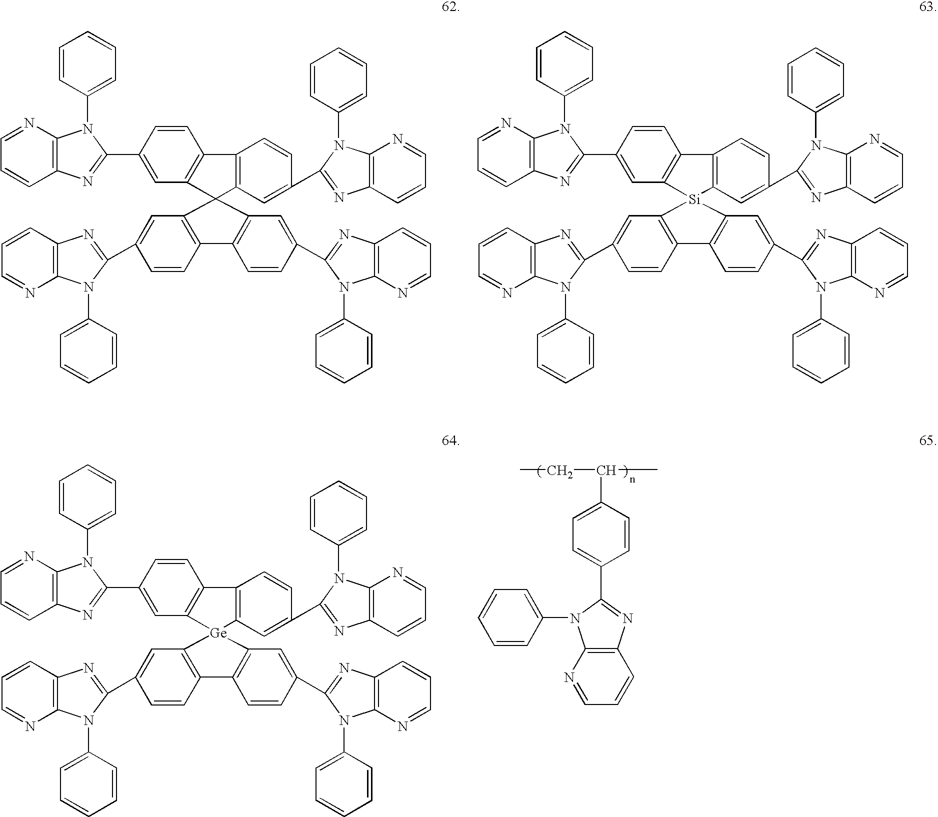

weight-average molecular weight (in terms of polystyrene): 16,500

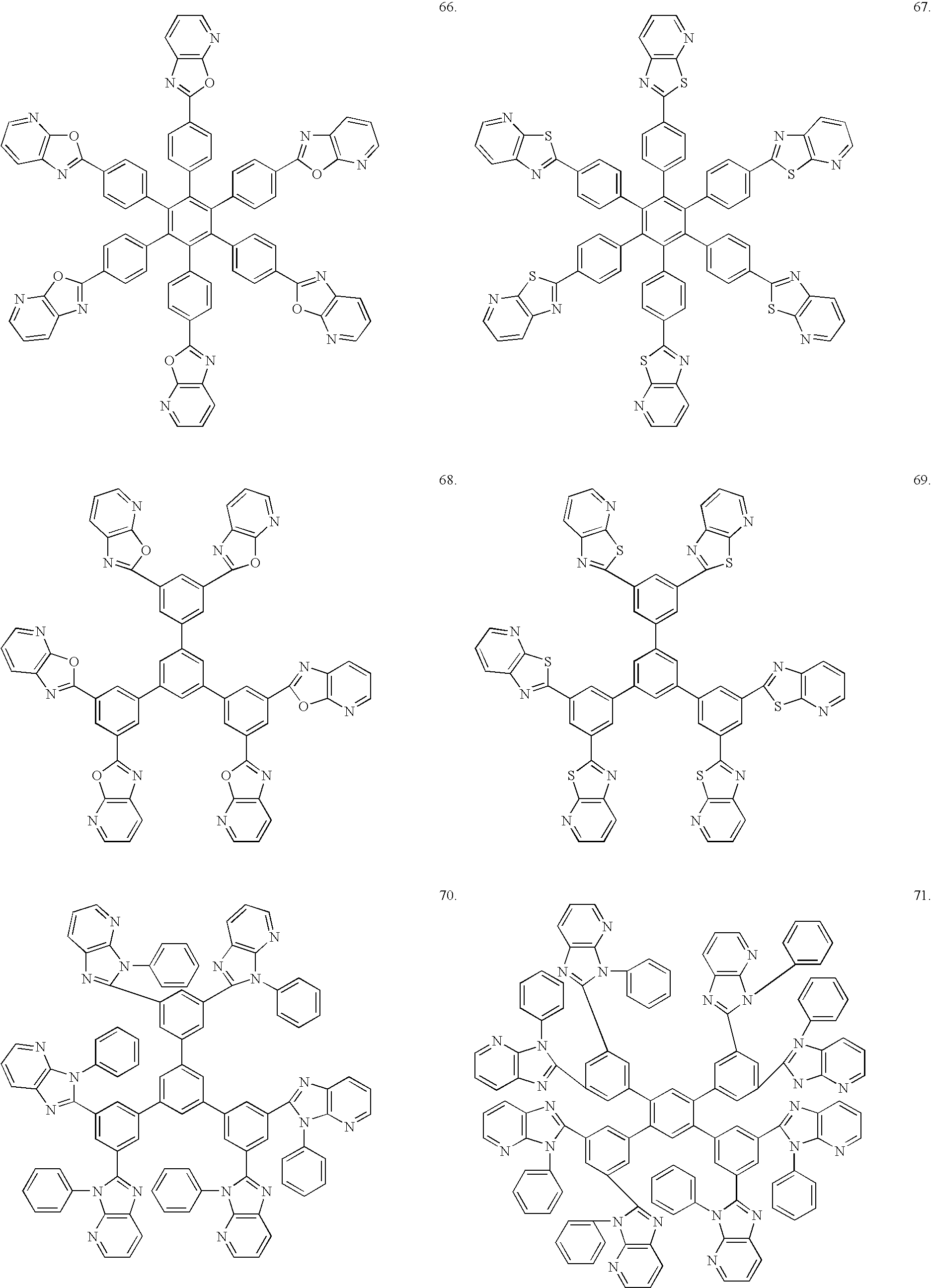

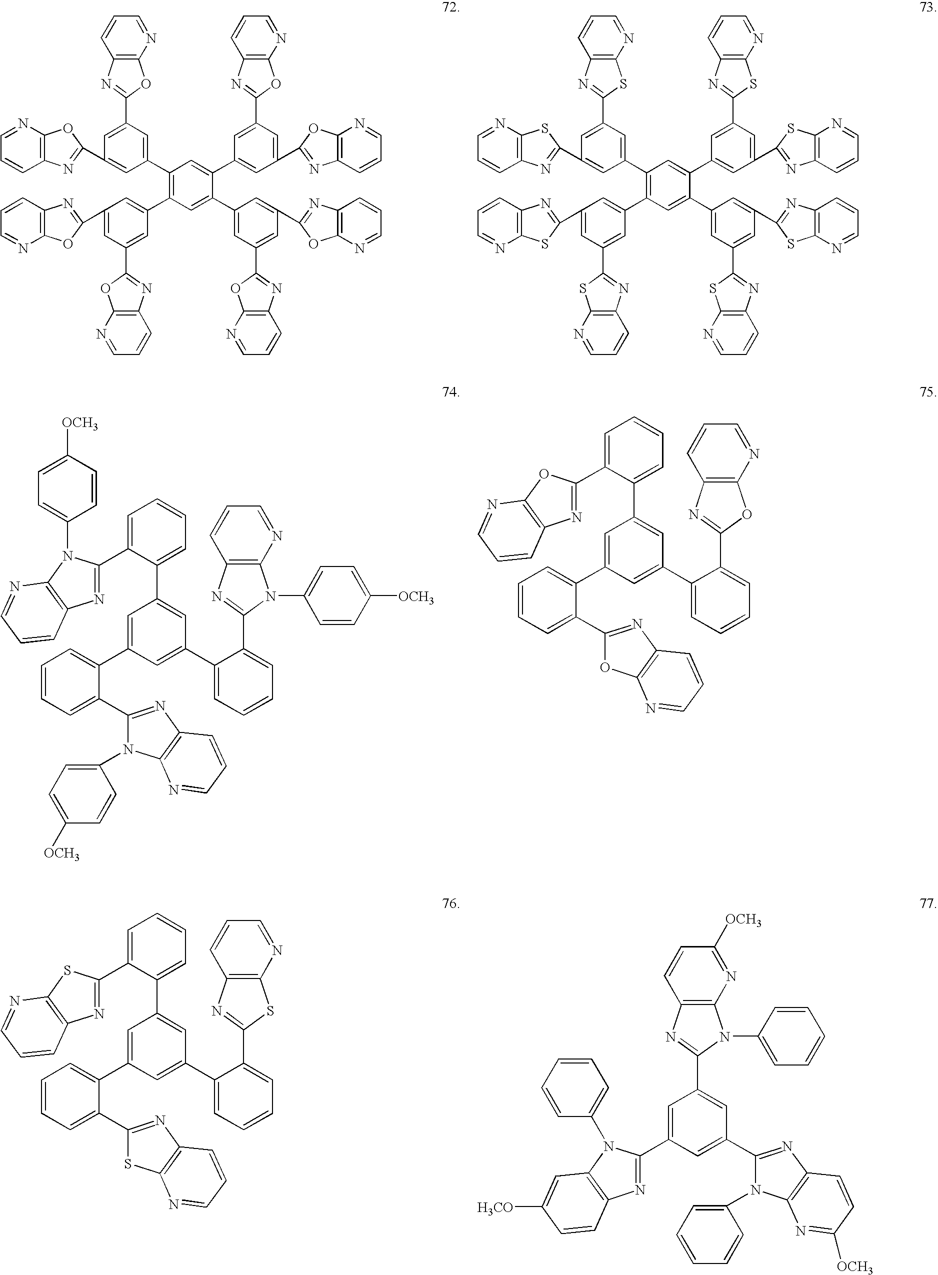

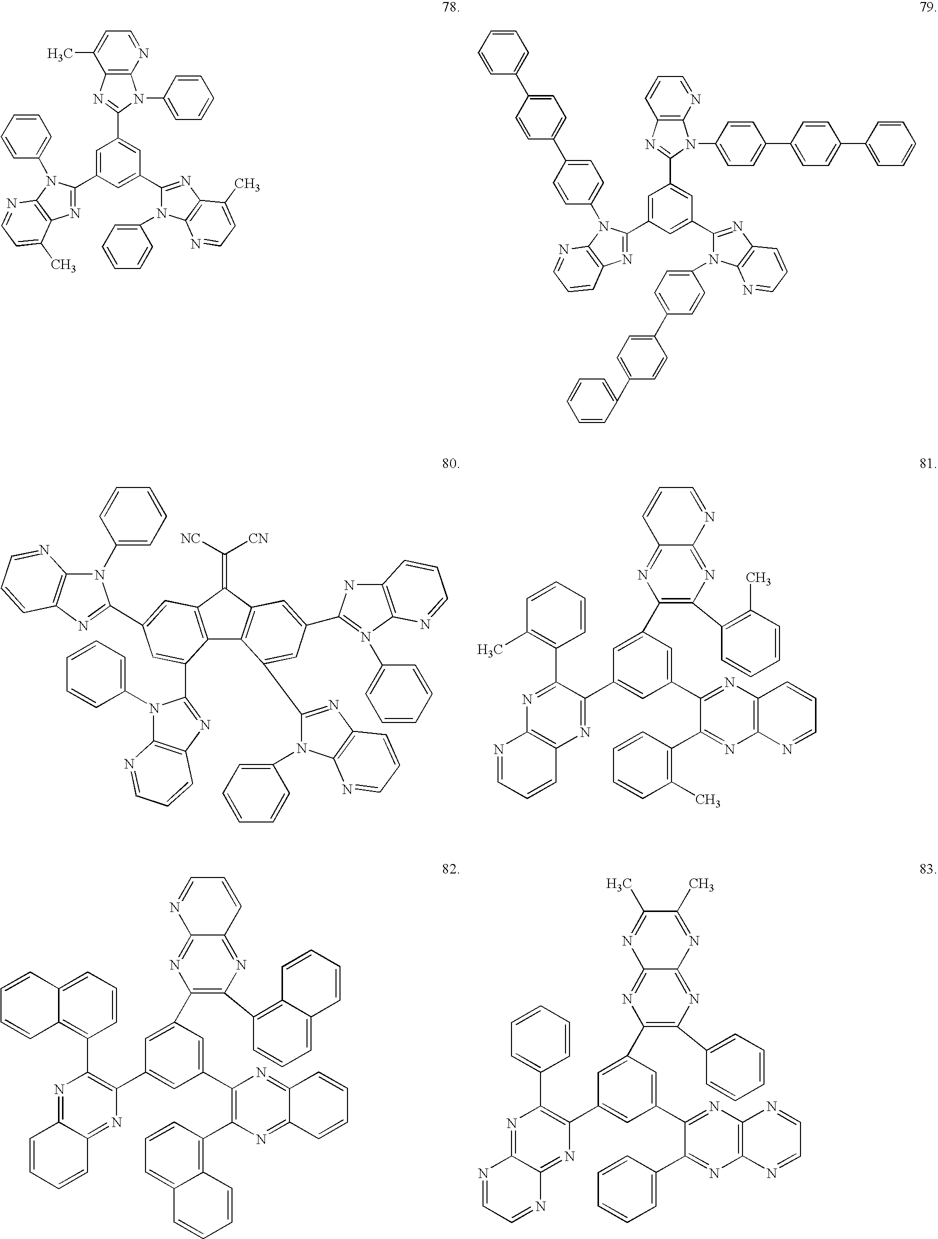

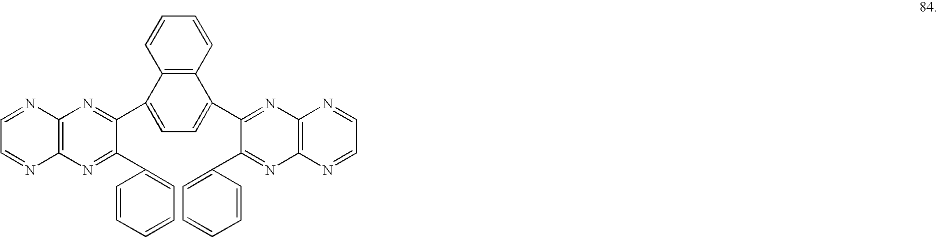

[2] Substrates

As the substrate for the organic electroluminescent element of the invention, any of transparent and opaque ones may be employed. Specific examples thereof include inorganic materials such as yttria-stabilized zirconia (YSZ) and glass and organic materials such as polyesters (e.g., polyethylene terephthalate, polybutylene phthalate and polyethylene naphthalate), polystyrene, polycarbonate, polyether sulfone, polyallylate, allyldiglycol carbonate, polyimide, polycycloolefin, norbornene resin and poly(chlolotrifluoroethylene). With the organic materials, those which are excellent in heat resistance, dimensional stability, solvent resistance, electrically insulating properties and workability are preferred. Also, in the case where an emitted light is taken out from the support side using a transparent electrode as the cathode, the substrate is preferably colorless and transparent in order to depress scattering and extinction of the emitted light.

In the invention, the substrate has a moisture permeability of 0.01 g/m²·day or less from the point of preventing invasion of moisture or oxygen into the element and improving durability and, more preferably, has an oxygen permeability of 0.01 cc/m²·day or less.

The moisture permeability can be measured according to JISK7129B mainly by MOCON method. The oxygen permeability can be measured according to JISK7126B mainly by MOCON method.

The substrate to be used in the invention has a thermal linear expansion coefficient of preferably 20 ppm/° C. or less from the point of preventing cracks or peeling of the electrodes or the organic layer upon cooling or heating with time. The thermal linear expansion coefficient is measured by a method of heating at a constant rate and detecting change in length of a sample, mainly by TMA method.

As the substrate to be used in the invention which satisfies the above-described physical properties and difficultly causes shortcircuiting upon forming the electrode film to produce the element, a substrate comprising a metal foil having provided on one side or both sides thereof an insulating layer is preferred.

In this case, the metal foil is not particularly limited, and a metal foil such as an aluminum foil, a copper foil, a stainless steel foil, a gold foil or a silver foil may be used. Of these, an aluminum foil or a copper foil is preferred in view of workability and production cost. The thickness of the metal foil is preferably 10 μm to 100 μm for obtaining a small moisture permeability and a small oxygen permeability to improve durability of the element and for imparting enough flexibility to ensure easy handling.

Also, there exist no particular limitations as to the insulating layer. For example, inorganic substances such as inorganic oxides and inorganic nitrides and plastics such as polyesters (e.g., polyethylene terephthalate, polybutylene phthalate and polyethylene naphthalate), polystyrene, polycarbonate, polyethersulfone, polyallylate, allyldiglycol carbonate, polyimide, polycycloolefin, norbornene resin, poly(chlorotrifluoroethylene) and polyimide may be used.

On this insulating layer are provided electrodes and organic layers. As has been described above, the thermal linear expansion coefficient of the insulating layer is preferably 20 ppm/° C. or less in view of avoiding cracks or peeling upon cooling or heating with time.

As such insulating layer, metal oxides such as silicon oxide, germanium oxide, zinc oxide, aluminum oxide, titanium oxide and copper oxide and metal nitrides such as silicon nitride, germanium nitride and aluminum nitride may preferably be used independently or in combination of two or more thereof.

In order to prevent formation of cracks or pinholes and maintain good insulating properties, the thickness of the metal oxide and/or metal nitride insulating layer is preferably 10 nm to 1000 nm.

The method for forming the metal oxide and/or metal nitride layer is not particularly limited, and there may be employed a dry method such as a vacuum deposition method, a sputtering method or a CVD method, a wet method such as a sol-gel method, or a method of dispersing metal oxide and/or metal nitride particles in a solvent and coating the dispersion.

As the insulating layer, plastic materials having a thermal linear expansion coefficient of 20 ppm/° C. or less, particularly polyimides or liquid crystal polymers may preferably be used. Detailed descriptions on the properties of these plastic materials are given in “Plastic Data Book” (Asahi Kasei Amidasu K.K.; compiled by “Plastic” compiling division), etc. In the case of using polyimide or the like as the insulating layer, it is possible to laminate a polyimide sheet and an aluminum foil to form a laminated film. In order to impart enough flexibility to facilitate handling upon laminating or the like, the thickness of the sheet of polyimide or the like is preferably 10 μm to 200 μm.

The insulating layer may be provided only on one side or both sides of the metal foil. In the case of providing on both sides, the metal oxide and/or metal nitride may be provided on both sides, or the sheet of polyimide or the like may be provided on both sides. Also, the metal oxide and/or metal nitride may be provided on one side, and the sheet of polyimide or the like may be provided on the other side.

In the invention, a hard coat layer or an undercoat layer may further be provided, as needed, on the substrate.

The substrate is not limited as to its shape, structure and size, and a proper one may be selected depending upon the use and purpose of the light-emitting element. Generally, a plate-shaped substrate is used.

[3] Electrode

Of a pair of electrodes, usually one is used as a transparent electrode on the light-emitting side, and the other is used as a backside electrode on the non-light-emitting side. Either of the cathode and the anode may be used as the transparent electrode or the backside electrode. In the invention, it is preferred to use the cathode as the backside electrode, and the anode as the transparent electrode, since such structure permits to take out the emitted light from the side of the organic layer opposite to the substrate.

(a) Anode

As the anode, usually those which function as an anode to feed holes to the organic layer may be used, and the shape, structure and size of the anode are not particularly limited. Proper electrodes may be selected from among known electrodes depending upon the use and purpose of the light-emitting element.

As materials for the anode, there are preferably illustrated, for example, metals, alloys, metal oxides, organic electrically conductive compounds and mixtures thereof, with those which have a work function of 4.0 eV or more being more preferred. Specific examples thereof include semi-conductive metal oxides such as tin oxide doped with antimony or fluorine (ATO or FTO), tin oxide, zinc oxide, indium oxide, indium tin oxide (ITO) and indium zinc oxide (IZO), metals such as gold, silver, chromium and nickel, mixtures or laminates of these metals and conductive metal oxides, inorganic electrically conductive materials such as copper iodide and copper sulfide, dispersions of the semi-conductive metal oxides or metal compounds, organic electrically conductive materials such as polyaniline, polythiophene and polypyrrole, and laminates of one of these and ITO.

The anode may be formed on a substrate according to a method properly selected from among wet methods such as a printing method and a coating method, physical methods such as a vacuum deposition method, a sputtering method and an ion plating method and chemical methods such as a CVD method and a plasma CVD method in consideration of compatibility with the aforesaid materials. For example, in the case of selecting ITO as the anode material, formation of the anode can be conducted according to a direct-current or high-frequency sputtering method, a vacuum deposition method or an ion plating method. Also, in the case of selecting the organic electrically conductive compound as the anode material, formation of the anode can be conducted according to the wet filming method. In order to enlarge the area of the element with a good productivity, the wet filming method is preferred.

Additionally, patterning of the anode may be conducted according to chemical etching by photolithography or the like, may be conducted according to physical etching by laser or the like, may be conducted by vacuum deposition or sputtering with superposing a mask, or may be conducted by a lift-off method or a printing method.

The thickness of the anode may properly be selected from among the aforesaid materials and is usually 10 nm to 50 μm, preferably 50 nm to 20 μm, though not being specified in a general manner.

The resistance value of the anode is preferably 10⁶ Ω/□ (Ω/square) or less, more preferably 10⁵ Ω/□ or less. In the case where the resistance value of the anode is less than 10⁵ Ω/□, large-area light-emitting elements having an excellent performance can be obtained by providing buss-line electrodes.

The anode may be colorless and transparent, colored and transparent, or opaque but, in the case where an emitted light is taken out from the anode side using a transparent anode, the anode has a percent transmission of preferably 60% or more, more preferably 70% or more. This percent transmission can be measured according to a known method using a spectrophotometer. As the transparent anode, those electrodes which are described in detail in “Tomei Dodenmaku No Sin-tenkai” (supervised by Yutaka Sawada and published by CMC in 1999) may also be employable in the invention. In particular, in the case of using a plastic substrate having a low heat resistance, it is preferred to use ITO or IZO as the anode and form the film thereof at a temperature as low as 150° C. or lower to form the transparent anode.

(b) Cathode

As the cathode, usually those which function as a cathode to inject electrons to the organic layer may be used, and the shape, structure and size of the cathode are not particularly limited. Proper cathodes may be selected from among known electrodes depending upon the use and purpose of the light-emitting element.

As materials for the cathode, there are illustrated, for example, metals, alloys, metal oxides, electrically conductive compounds and mixtures thereof, with those which have a work function of 4.5 eV or more being more preferred. Specific examples thereof include alkali metals (e.g., Li, Na, K and Cs), alkaline earth metals (e.g., Mg and Ca), gold, silver, lead, aluminum, sodium-potassium alloy, lithium-aluminum alloy, magnesium-silver alloy, and rare earth metals such as indium and ytterbium. These may be used independently but, in view of obtaining both stability and electron-injecting properties, two or more of them may be used in combination.

Among them, alkali metals and alkaline earth metals are preferred in view of electron-injecting properties, and materials containing aluminum as a major component are preferred in the point of excellent storage stability thereof. Here, the materials containing aluminum as a major component means aluminum itself, or an alloy or mixture of aluminum and 0.01 to 10% by weight of an alkali metal or an alkaline earth metal (for example, lithium-aluminum alloy or magnesium-aluminum alloy).

In the case of taking out an emitted light from the cathode side, it is necessary to use a transparent cathode. It suffices for the transparent cathode to be substantially transparent for the light. In order to obtain both electron-injecting properties and transparency, it is possible to employ a two-layered structure of a thin film metal layer and a transparent conductive layer. Additionally, materials for the thin film metal layer are described in detail in JP-A-2-15595 and JP-A-5-121172. The thickness of the thin film metal layer is preferably 1 nm to 50 nm in view of filming a uniform film and maintaining good transparency.

As materials to be used for the transparent conductive layer in the two-layer structured cathode, any material that has an electric conductivity or semi-conductivity and is transparent may be used without particular limitation, and those which have been referred to with respecto to the anode may preferably be used. Among them, tin oxide doped with antimony or fluorine (ATO or FTO), tin oxide, zinc oxide, indium oxide, indium tin oxide (ITO) and indium zinc oxide (IZO) are particularly illustrated. The thickness of the transparent conductive layer is preferably 30 nm to 500 nm in view of conductivity (semi-conductivity) and productivity.

Methods for forming the cathode are not particularly limited, and it can be formed according to a publicly known method. In the invention, the formation is conducted in a vacuum device. For example, the cathode can be formed on the substrate according to a method properly selected from among physical methods such as a vacuum deposition method, a sputtering method and an ion plating method and chemical methods such as a CVD method and a plasma CVD method in consideration of compatibility with the aforesaid materials. For example, in the case of selecting a metal as the cathode material, formation of the anode can be conducted by sputtering one metal or two or more metals at the same time or in turn. Also, in the case of selecting the organic electrically conductive material as the cathode material, formation of the cathode can be conducted according to the wet filming method. Additionally, patterning of the cathode may be conducted according to chemical etching by photolithography or the like, may be conducted according to physical etching by laser or the like, may be conducted by vacuum deposition or sputtering with superposing a mask, or may be conducted by a lift-off method or a printing method.

[4] Organic layer

In the invention, the organic layer comprises one or more layers including at least a light-emitting layer. In addition to the light-emitting layer, an electron injecting organic layer, an electron transporting organic layer, a hole transporting organic layer and a hole injecting organic layer may be provided as needed.

As to the position of the organic layer in the organic electroluminescent element of the invention, it is formed on the cathode as has been described hereinbefore. In this case, the organic layer is formed on the front surface or one side.

The organic layer is not particularly limited as to its shape, size and thickness, and they are properly selected depending upon the purpose thereof.

(a) Light-Emitting Layer

The light-emitting layer contains at least one light-emitting compound. The light-emitting compound is not particularly limited, and may be a fluorescent light-emitting compound or a phosphorescent light-emitting compound. It is also possible to use the fluorescent light-emitting compound and the phosphorescent light-emitting compound at the same time. In the invention, the phosphorescent light-emitting compound is preferably used in view of luminance of emitted light and light-emitting efficiency.

Additionally, the term “derivative” as used herein in the specification means the compound itself and the derivatives thereof.

Examples of the fluorescent light-emitting compound include benzoxazole derivatives, benzimidazole derivatives, benzothiazole derivatives, styrylbenzene derivatives, polyphenyl derivatives, diphenylbutadiene derivatives, tetraphenylbutadiene derivatives, naphthalimide derivatives, coumarin derivatives, perylene derivatives, perynone derivatives, oxadiazole derivatives, aldazine derivatives, pyralidine derivatives, cyclopentadiene derivatives, bis(styryl) anthracene derivatives, quinacridone derivatives, pyrrolopyridine derivatives, thiadiazolopyridine derivatives, styrylamine derivatives, aromatic dimethylidene compounds, various metal complexes represented by metal complexes of 8-quinolinol derivatives, rare earth metal complexes, and high molecular compounds such as polythiophene derivatives, polyphenylene derivatives, polyphenylenevinylene derivatives and polyfluorene derivatives. These may be used independently or as a mixture of two or more of them.

The phosphorescent light-emitting compound is not particularly limited, but ortho-metalated metal complexes or porphyrin metal complexes are preferred. Of the porphyrin metal complexes, porphyrin platinum complex is preferred. The phosphorescent light-emitting compounds may be used independently or as a mixture of two or more of them.

The term “orthometalated metal complexes to be used in the invention is a general term for compounds described in “Yuki Kinzoku Kagaku, Kiso To Oyo” written by Akio Yamamoto and published by Shokabo Sha in year 1982, pp. 150 and 232; and “Photochemistry and Photophysics of Coordination Compounds” written by H. Yersin and published by Springer-Verlag Co. in year 1987, pp. 71 to 77 and 135 to 146. Ligands for forming the orthometalated metal complexes are not particularly limited, but are preferably 2-phenylpyridine derivatives, 7,8-benzoquinoline derivatives, 2-(2-thienyl)pyridine derivatives, 2-(1-naphthyl)pyridine derivatives or 2-phenylquinoline derivatives. These derivatives may have a substituent or substituents. Also, in addition to these ligands necessary for forming the orthometalated metal complexes, other ligands may exist. As a central metal forming the orthometalated metal complex, any of transition metals may be used. In the invention, rhodium, platinum, gold, iridium, ruthenium and palladium can preferably be used. The organic layer containing such orthometalated metal complex is excellent in emitted light luminance and light-emitting efficiency. As to the orthometalated metal complexes, specific examples are described in Japanese Patent Application No. 2000-254171.

The orthometalated metal complexes can be synthesized by known processes described in Inorg. Chem., 30, 1685, 1991; Inorg. Chem., 27, 3464, 1988; Inorg. Chem., 33, 545, 1994; Inorg. Chim. Acta, 181, 245, 1991; J. Organomet. Chem., 335, 293, 1987; and J. Am. Chem. Soc., 107, 1431, 1985.

The content of the light-emitting compound in the light-emitting layer is not particularly limited but, in order to maintain light-emitting properties at a good level, the content is preferably 0.1 to 70% by weight, more preferably 1 to 20% by weight.

The light-emitting layer may contain, if necessary, a host compound, a hole transporting material, an electron transporting material and an electrically inert polymer binder. Additionally, in some cases, functions of these materials can be conducted by one compound. For example, carbazole derivatives function not only as a host compound but as a hole transporting material as well.

The host compound is a compound which, when excited, causes energy trapsportation to a light-emitting compound to make the light-emitting compound emit light. Specific examples thereof include carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidene compounds, porphyrin compounds, anthraquinodimethane derivatives, anthrone derivatives, diphenylquinone derivatives, thiopyran dioxide derivatives, carbodiimide derivatives, fluorenylidenemethane derivatives, distyrylpyrazine derivatives, tetracarboxylic acid anhydrides of naphthalene or perylene, phthalocyanine derivatives, metal complexes of, for example, 8-quinolinol derivatives, metallophthalocyanines, metal complexes containing benzoxazole orbenzothiazole as a ligand, conductive high polymers such as polysilane compounds, poly(N-vinylcarbazole) derivatives, aniline copolymers, thiophene oligomers and polythiophene, polythiophene derivatives, polyphenylene derivatives, polyphenylenevinylene derivatives, and polyfluorene derivatives. The host compounds may be used independently or in combination of two or more thereof. The content of the host compound in the light-emitting layer is preferably 0 to 99.9% by weight, more preferably 0 to 99.0% by weight.

The hole transporting material is not particularly limited as long as it exerts one of the function of injecting holes from the anode, the function of transporting holes, and the function of blocking electrons injected from the cathode, and may be a low-molecular compound or a high-molecular compound. Specific examples thereof include carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidene compounds, porphyrin compounds, conductive high polymers such as polysilane compounds, poly(N-vinylcarbazole) derivatives, aniline copolymers, thiophene oligomers and polythiophene, polythiophene derivatives, polyphenylene derivatives, polyphenylenevinylene derivatives, and polyfluorene derivatives. These may be used independently or in combination of two or more thereof. The content of the hole transporting material in the light-emitting layer is preferably 0 to 99.9% by weight, more preferably 0 to 80.0% by weight.

The electron transporting material is not particularly limited as long as it exerts one of the function of injecting electrons from the cathode, the function of transporting electrons, and the function of blocking holes injected from the anode, and those which have been illustrated as electron transporting organic materials to be used in the aforesaid mixture layer may be used independently or as a mixture of two or more of them. The content of the electron transporting material in the light-emitting layer is preferably 0 to 99.9% by weight, more preferably 0 to 80.0% by weight.

As the polymer binder, polyvinyl chloride, polycarbonate, polystyrene, polymethyl methacrylate, polybutyl methacrylate, polyester, polysulfone, polyphenylene oxide, polybutadiene, hydrocarbon resin, ketone resin, phenoxy resin, polyamide, ethyl cellulose, vinyl acetate, ABS resin, polyurethane, melamine resin, unsaturated polyester, alkyd resin, epoxy resin, silicone resin, polyvinyl butyral and polyvinyl acetal may be used. These may be used alone or in combination of two or more of them. The light-emitting layer containing the polymer binder can easily be coated according to the wet filming method to form a large-area element.

The thickness of the light-emitting layer is preferably 10 to 200 nm, more preferably 20 to 80 nm, in view of preventing short-circuiting of the element and reducing driving voltage.

(b) Hole Transporting Organic Layer and Hole Injecting Organic Layer

In the invention, a hole transporting organic layer or a hole injecting organic layer comprising the above-described hole transporting material may be provided as needed. These layers may contain the above-described polymer binder. The thickness of each layer is preferably 10 to 200 nm, more preferably 20 to 80 nm, in view of preventing short-circuiting of the element and reducing driving voltage.

(c) Electron Transporting Organic Layer and Electron Injecting Organic Layer

In the invention, an electron transporting organic layer or an electron injecting organic layer comprising the above-described electron transporting material may be provided as needed. These layers may contain the above-described polymer binder. The thickness of each layer is preferably 10 to 200 nm, more preferably 20 to 80 nm, in view of preventing short-circuiting of the element and reducing driving voltage.

(d) Formation of the Organic layer

The organic layer can favorably be formed by any of dry film-forming methods such as a vacuum deposition method and a sputtering method and wet film-forming methods such as a dipping method, a spin coating method, a dip coating method, a cast coating method, a die coating method, a roll coating method, a bar coating method and a gravure coating method.

Formation of the organic layer by the wet coating method is advantageous in that the organic layer can easily be enlarged and that a light-emitting element capable of emitting light with a highly bright luminance and an excellent light-emitting efficiency can be obtained at a low production cost in a high efficiency. Additionally, a proper film-forming method can be selected depending upon the material of the organic layer.

In the case of forming the layer according to the wet film-forming method, drying may properly be conducted after formation of the film. Conditions for such drying are not particularly limited, and a temperature within a range of not damaging the layer formed by coating may be employed.

In the case of forming the organic layer by wet coating method, a binder resin may be added to the organic layer. In this case, examples of the binder resin include polyvinyl chloride, polycarbonate, polystyrene, polymethyl methacrylate, polybutylmethacrylate, polyester, polysulfone, polyphenylene oxide, polybutadiene, hydrocarbon resin, ketone, resin, phenoxy resin, polyamide, ethyl cellulose, vinyl acetate, ABS resin, polyurethane, melamine resin, unsaturated polyester, alkyd resin, epoxy resin, silicone resin, polyvinyl butyral and polyvinyl acetal. These may be used alone or in combination of two or more of them.

Also, in the case of forming the organic layer by wet coating method, solvents to be used upon preparation of a coating solution by dissolving the organic layer are not particularly limited, and a proper one may be selected depending upon kinds of the hole transporting material, the orthometalated metal complex, the host compound and the polymer binder. Examples of the solvent include halogen-containing solvents such as chloroform, carbon tetrachloride, dichloromethane, 1,2-dichloroethane and chlorobenzene, ketone solvents such as acetone, methyl ethyl ketone, diethyl ketone, n-propyl methyl ketone and cyclohexanone, aromatic solvents such as benzene, toluene and xylene, ester solvents such as ethyl acetate, n-propyl acetate, n-butyl acetate, methyl propionate, ethyl propionate, γ-butyrolactone and diethyl carbonate, ether solvents such as tetrahydrofuran and dioxane, amide solvents such as dimethylformamide and dimethylacetamide, dimethylsulfoxide and water.

Additionally, the amount of solid components in the coating solution is not particularly limited, and its viscosity can freely be selected depending upon the selected wet film-forming method.

(e) Patterning

A mask having a finely patterned opening (fine mask) is used for forming a finely patterned organic layer. Materials for the mask are not limited, but those which are durable and inexpensive such as metals, glass, ceramics and heat-resistant resins are preferred. These materials may be used in combination thereof. Also, mainly in view of mechanical strength, the thickness of the mask is preferably 2 to 100 μm, more preferably 5 to 60 μm.

[5] Other Layers

In the organic electroluminescent element of the invention may be provided a protective layer or a sealing layer in order to prevent deterioration of light-emitting performance of the element.

(a) Protective layer

As the protective layer, there are illustrated those which are described in JP-A-7-85974, JP-A-7-192866, JP-A-8-22891, JP-A-10-275682 and JP-A-10-106746. The protective layer is Formed on the uppermost surface of the element. In the invention wherein a substrate, a cathode, an organic layer and an anode are stacked in this order, the term “uppermost surface” as used herein means the outer surface of the anode. The protective layer is not particularly limited as to its shape, size and thickness. Materials constituting the protective layer are not particularly limited, and any material may be used that has the function of depressing invasion or transmission of substances which deteriorate the organic thin film element such as moisture or oxygen into the element. For example, silicon monoxide, silicon dioxide, germanium monoxide and germanium dioxide may be used.

The method for forming the protective layer is not particularly limited, and there may be applied, for example, a vacuum deposition method, a sputtering method, a reactive sputtering method, a molecular beam epitaxy method, a cluster ion beam method, an ion plating method, a plasma polymerization method, a plasma CVD method, a laser CVD method, a thermal CVD method and a coating method.

(b) Sealing Layer

A sealing layer for preventing invasion of moisture or oxygen may be provided in the organic electroluminescent element of the invention. As the materials for forming the sealing layer, there may be used a copolymer of tetrafluoroethylene and at least one comonomer, a fluorine-containing copoloymer containing a cyclic structure in the main chain of the copolymer, polyethylene, polypropylene, polymethyl methacrylate, polyimide, polyurea, polytetrafluoroethylene, poloychlorotrifluoroethylene, polydichlorodifluoroethylene, a copolymer of chlorotrifluoroethylene or dichlorodifluoroethylene and other comonomer, a water-absorbing substance having a water absorption of 1% or more, a moisture-resistant substance of 0.1% or less, a metal (In, Sn, Pb, Au, Cu, Ag, Al, Ti or Ni), a metal oxide (MgO, SiO, SiO₂, Al₂O₃, GeO, NiO, CaO, BaO, Fe₂O₃, Y₂O₃ or TiO₂), a metal fluoride (MgF₂, LiF, AlF₃ or CaF₂), a liquid fluorinated carbon (perfluoroalkane, perfluoroamine or perfluoroether), and a dispersion of an absorbent for moisture or oxygen in a liquid fluorinated carbon.

In order to block moisture or oxygen from outside, it is preferred to seal the organic layer by a sealing member such as a sealing plate or a sealing vessel. The sealing member may be provided only on the anode side, or the light-emitting laminate (laminate containing the cathode, the organic layer, the anode and other layer) may wholly be covered by the sealing member. The sealing member is not limited as to its shape, size and thickness so long as the organic layer can be sealed and the outer air can be blocked. As materials to be used for the sealing member, glass, stainless steel, metal (aluminum, etc.), plastic (polychlorotrifluoroethylene, polyester, polycarbonate, etc.) and ceramic may be used.

Upon providing the sealing member onto the light-emitting laminate, a sealant (adhesive) may be used as needed. In the case where the light-emitting laminate is wolly covered by the sealing member, it is also possible to heat-weld parts of the member to each other without using the sealant. As the sealant, UV-curing resins, thermosetting resins and two-part curable resins may be used.

In the case of wholly covering the light-emitting laminate, a moisture absorbent or an inert liquid may be placed in the space between the sealing member and the light-emitting laminate. The moisture absorbent is not particularly limited, and specific examples thereof include barium oxide, sodium oxide, potassium oxide, calcium oxide, sodium sulfate, calcium sulfate, magnesium sulfate, phosphorus pentoxide, calcium chloride, magnesium chloride, copper chloride, cesium fluoride, niobium fluoride, calcium bromide, vanadium bromide, molecular sieve, zeolite and magnesium oxide. As the inert liquid, paraffins, liquid paraffins, fluorine-containing solvents (perfluoroalkane, perfluoroamine and perfluoroether), chlorine-containing solvents and silicone oils may be used.

[6] Driving the Element

The organic electroluminescent element of the invention emits light when a direct current volt (usually 2 to 40 v) (optionally containing an alternating current component) or a direct current is applied across the anode and the cathode.

As to driving of the light-emitting element of the invention, methods described in JP-A-2-148687, JP-A-6-301355, JP-A-5-29080, JP-A-7-134558, JP-A-8-234685, JP-A-8-241047, U.S. Pat. No. 5,828,429, U.S. Pat. No. 6,023,308 and Japanese Patent No. 2,784,615 may be utilized.

### EXAMPLES

The invention is described in more detail below. However, the invention should not be construed as being limited thereto.

### Example 1

A polyimide sheet (Upilex 50S; 50 μm in thickness; manufactured by Ube Industries, Ltd.) was laminated on both sides of a 5-cm square aluminum foil (30 μm thick) using an adhesive to prepare a supporting substrate of the invention. Additionally, the substrate had a thermal linear expansion coefficient of 10 ppm/° C. (measured according to TMA). Also, the substrate had a moisture permeability of 0.01 g/m²·day or less (measured according to MOCON method at 25° C. and 90% RH) and an oxygen permeability of 0.01 g/m²·day or less (measured according to MOCON method at 25° C. and 0% RH).

A cathode with a predetermined pattern was formed on this substrate by the vacuum deposition method using a stainless steel-made shadow mask. The cathode was formed by depositing Al in a film thickness of 250 nm in a reduced-pressure atmosphere of about 0.1 mPa. On this cathode was formed a mixture layer of 36 nm in thickness by using the aforesaid compound (21) as an electron transporting material and using LiF with adjusting the vacuum deposition rates of respective materials so that the content of LiF became 10% by weight based on the compound.

Further, a solution of polyvinylcarbazole/tris(2-phenylpyridine)iridium complex (40/1 (by weight)) in dichloroethane was coated on the mixture layer using a spin coater to prepare a 0.1-μm thick light-emitting layer. Still further, N,N′-dinaphthyl-N,N′-diphenylbenzidine was vacuum deposited at a rate of 1 nm/sec to form a 0.04-μm thick hole transporting layer.

Still further, a 0.2 μm thick ITO thin film (transparent anode) was formed thereon by DC magnetron sputtering (conditions: 100° C. in substrate temperature; 1×10⁻³ Pa in oxygen pressure) using an ITO target having an In₂O₃ content of 95% by weight. The ITO thin film had a surface resistance of 10 Ω/□. Aluminum lead wires were connected to the transparent anode and the cathode, respectively, to form a light-emitting laminate. This was placed in an argon gas-replaced globe box and was sealed using a glass-made sealing vessel and a UV-curing adhesive (XNR5493T; made by Nagase Ciba) to obtain the organic electroluminescent element 101.

An element 102 was prepared in the same manner as with the element 101 except for changing the inorganic metal salt in the mixture layer to MgF₂ and changing the electron transporting organic material in the layer to the compound (2).

Further, elements 103 to 108 were prepared by changing the inorganic metal salt and the electron transporting organic material in the mixture layer as shown in Table 1.

### Comparative Example 1

An element 109 was prepared in the same manner as with the element 101 except for vacuum depositing LiF in a film thickness of 3 nm with the same pattern on the Al-deposited substrate and vacuum depositing thereon the compound (21) at a rate of 1 nm/sec to form a 0.03-um layer.

### Comparative Example 2

An element 110 was prepared in the same manner as with the element 101 except for using the following compound in place of the compound (21).

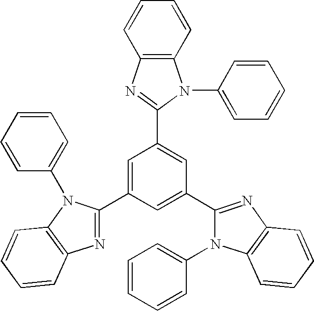

The thus obtained elements were evaluated in the following manner.

A direct current voltage was applied to each of the organic EL elements to emit light using a source measure unit Model 2400 made by Toyo Technica Corp. The maximum luminance was referred to as Lₘₐₓ, and the volt at which Lₘₐₓ was obtained was referred to as Vₘₐₓ. The light-emitting efficiency at 200 cd/m² was referred to as outer quantum efficiency (η₂₀₀). Existence or absence of defect (dark spots) were visually checked. The defect was evaluated in terms of number of spots having an area of 1 mm².

5 or less: ◯

6 to 20: Δ

21 or more: x

Results of the evaluation are tabulated in Table 1.

TABLE 1

| Ele- | Inorganic | Electron | | | | Degree | |
|---|---|---|---|---|---|---|---|
| ment | Metal | Transporting | Lₘₐₓ | Vₘₐₓ | η₂₀₀ | of | |
| No. | Salt | Material | (cd/m²) | (V) | (%) | Defect | Note |
| 101 | LiF | (21) | 36000 | 12 | 13.2 | ∘ | * |
| 102 | LiF | (2) | 47000 | 12 | 12.1 | ∘ | * |
| 103 | LiF | (18) | 32000 | 13 | 11.8 | ∘ | * |
| 104 | MgF₂ | (21) | 41000 | 13 | 12.4 | ∘ | * |
| 105 | MgF₂ | (19) | 41000 | 11 | 14.2 | ∘ | * |
| 106 | MgF₂ | (24) | 35000 | 12 | 13.5 | ∘ | * |
| 107 | CaF₂ | (26) | 44000 | 11 | 14.1 | ∘ | * |
| 108 | CaF₂ | (81) | 37000 | 13 | 13.2 | ∘ | * |
| 109 | — | (21) | 8000 | 19 | 4.4 | Δ | ** |
| 110 | LiF | — | 3000 | 18 | 3.6 | x | ** |

*: present invention

As is apparent from Table 1, the organic electroluminescent elements of the invention emitted light with a high luminance and in a high yield at a low driving voltage. Also, they showed extremely less defects.

The organic electroluminescent elements of the invention can be driven at a low driving voltage, and show markedly improved light-emitting properties with emitting light with a high luminance in a high yield. Also, they provide a wide choice of substrate materials and, in the case of using them as a light source for a display, they enables one to realize a high opening ratio.

This application is based on Japanese Patent application JP 2002-361110, filed Dec. 12, 2002, the entire content of which is hereby incorporated by reference, the same as if set forth at length.

What is claimed is:

1. An organic electroluminescent element comprising:
a substrate;
a cathode;
at least one organic layer, at least one of the at least one organic layer being a light-emitting layer; and
an anode,
wherein the element further comprises a mixture layer containing an inorganic metal salt and an electron transporting organic material so that the cathode, the mixture layer and the organic layer are in this order, and the electron transporting organic material is at least one of compounds represented by the formula (A-I) and the formula (B-I): 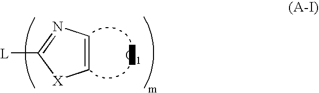
wherein X represents O, S, Se, Te or N—R, R represents a hydrogen atom, an aliphatic hydrocarbyl group, an aryl group or a heterocyclic group, Q₁ represents atoms necessary for forming an aromatic heterocyclic ring, m represents an integer of 2 or more, and L represents a linking group; 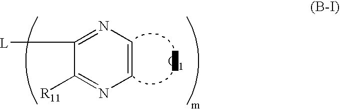
wherein R₁₁ represents a hydrogen atom or a substituent, Q represents atoms necessary for forming an aromatic heterocyclic ring, m represents an integer of 2 or more, and L represents a linking group.

2. The organic electroluminescent element of claim 1, wherein the inorganic metal salt is at least one of an alkali metal salt and an alkaline earth metal salt.

3. The organic electroluminescent element of claim 1, wherein a concentration of the inorganic metal salt in the mixture layer is 0.1 to 99.0% by weight.

4. The organic electroluminescent element of claim 1, wherein a concentration of the inorganic metal salt in the mixture layer is 1.0 to 80.0% by weight.

5. The organic electroluminescent element of claim 1, wherein the compound of the formula (A-I) is a compound of the formula (A-II): 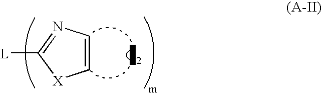
wherein X represents O, S, Se, Te or N—R, R represents a hydrogen atom, an aliphatic hydrocarbyl group, an aryl group or a heterocyclic group, m represents an integer of 2 or more, L represents a linking group, and Q₂ represents atoms necessary for forming a nitrogen-containing aromatic heterocyclic ring.

6. The organic electroluminescent element of claim 1, wherein the compound of the formula (A-I) is a compound of the formula (A-III): 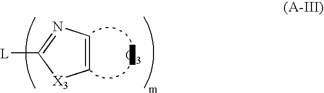
wherein m represents an integer of 2 or more, L represents a linking group, X₃ represents O, S or N—R, R represents a hydrogen atom, an aliphatic hydrocarbyl group, an aryl group or a heterocyclic group, and Q₃ represents atoms necessary for forming a nitrogen-containing aromatic heterocyclic ring.

7. The organic electroluminescent element of claim 1, wherein the compound of the formula (A-I) is a compound of the formula (A-IV): 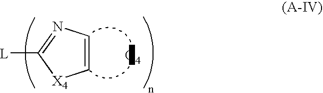
wherein L represents a linking group, X₄ represents O, S or N—R, R represents a hydrogen atom, an aliphatic hydrocarbyl group, an aryl group or a heterocyclic group, Q₄ represents atoms necessary for forming a nitrogen-containing aromatic heterocyclic ring, n represents an integer of 2 to 8.

8. The organic electroluminescent element of claim 1, wherein the compound of the formula (A-I) is a compound of the formula (A-V): 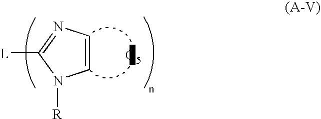
wherein L represents a linking group, R represents a hydrogen atom, an aliphatic hydrocarbyl group, an aryl group or a heterocyclic group, Q₅ represents atoms necessary for forming a nitrogen-containing aromatic heterocyclic ring, and n represents an integer of 2 to 8.

9. The organic electroluminescent element of claim 1, wherein the compound of the formula (A-I) is a compound of the formula (A-VI): 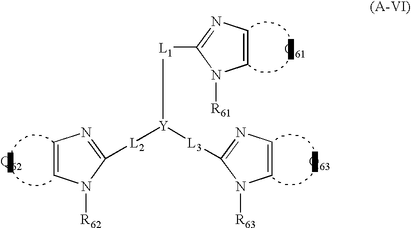
wherein R₆₁, R₆₂ and R₆₃ each independently represents a hydrogen atom, an aliphatic hydrocarbyl group, an aryl group or a heterocyclic group, Q₆₁, Q₆₂ and Q₆₃ each independently represents atoms necessary for forming a nitrogen-containing aromatic heterocyclic ring, L₁, L₂ and L₃ each independently represents a linking group, and Y represents a nitrogen atom or a 1,3,5-benzenetriyl group.

10. The organic electroluminescent element of claim 1, wherein the compound of the formula (A-I) is a compound of the formula (A-VII): 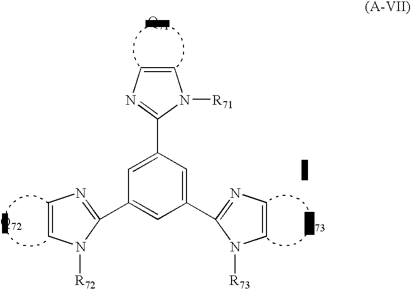
wherein R₇₁, R₇₂ and R₇₃ each independently represents a hydrogen atom, an aliphatic hydrocarbyl group, an aryl group or a heterocyclic group, and Q₇₁, Q₇₂ and Q₇₃ each independently represents atoms necessary for forming a nitrogen-containing aromatic heterocyclic ring

11. The organic electroluminescent element of claim 1, wherein the compound of the formula (A-I) is a compound of the formula (A-VIII): 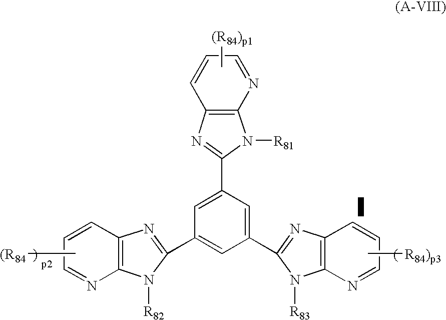
wherein R₈₁, R₈₂ and R₈₃ each independently represents a hydrogen atom, an aliphatic hydrocarbyl group, an aryl group or a heterocyclic group, R₈₄, R₈₅ and R₈₆ each independently represents an alkyl group, an alkenyl group, an alkynyl group, an aryl group, an amino group, an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a sulfonyl group, a halogen atom, a cyano group or a heterocyclic group, p₁, p₂ and p₃ each independently represents an integer of 0 to 3.

12. The organic electroluminescent element of claim 1, wherein the compound of the formula (B-I) is a compound of the formula (B-II): 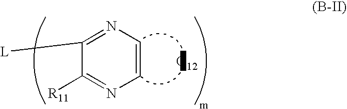
wherein m represents an integer of 2 or more, L represents a linking group, Q₁₂ represents atoms necessary for forming a nitrogen-containing aromatic heterocyclic ring, and R₁₁ represents a hydrogen atom or a substituent.

13. The organic electroluminescent element of claim 1, wherein the compound of the formula (B-I) is a compound of the formula (B-III): 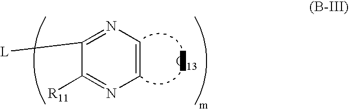
wherein m represents an integer of 2 or more, L represents a linking group, Q₁₃ represents atoms necessary for forming a nitrogen-containing aromatic heterocyclic ring, and R₁₁ represents a hydrogen atom or a substituent.

14. The organic electroluminescent element of claim 1, wherein the compound of the formula (B-I) is a compound of the formula (B-IV): 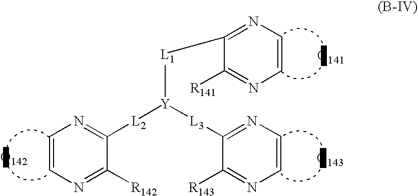
wherein L₁, L₂ and L₃ each independently represents a linking group, Y represents a nitrogen atom or a 1,3,5-benzenetriyl group, Q₁₄₁, Q₁₄₂ and Q₁₄₃ each independently represents atoms necessary for forming a nitrogen-containing aromatic heterocyclic ring, and R₁₄₁, R₁₄₂ and R₁₄₃ each independently represents a hydrogen atom or a substituent.

15. The organic electroluminescent element of claim 1, wherein the compound of the formula (B-I) is a compound of the formula (B-V): 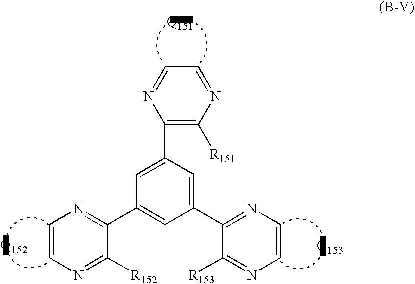
wherein Q₁₅₁, Q₁₅₂ and Q₁₅₃ each independently represents atoms necessary for forming a nitrogen-containing aromatic heterocyclic ring, and R₁₅₁, R₁₅₂ and R₁₅₃ each independently represents a hydrogen atom or a substituent.
